(19) United States
(12) Patent Application Publication
(10) Pub. No.: US 2020/0134939 A1
(43) Pub. Date: Apr. 30, 2020

(54) APPARATUS AND METHOD FOR VEHICULAR MONITORING, ANALYSIS, AND CONTROL

(71) Applicants: Carl H. Schell, Waterford, MI (US); Jeffrey T. Root, Howell, MI (US); Lynn DaDeppo, Bloomfield Hills, MI (US); Marcello Tedesco, Fort Gratiot, MI (US); Ehab Kamal, Oro Valley, AZ (US)

(72) Inventors: Carl H. Schell, Waterford, MI (US); Jeffrey T. Root, Howell, MI (US); Lynn DaDeppo, Bloomfield Hills, MI (US); Marcello Tedesco, Fort Gratiot, MI (US); Ehab Kamal, Oro Valley, AZ (US)

(73) Assignee: APPLIED MECHATRONIC PRODUCTS, LLC

(21) Appl. No.: 16/350,285

(22) Filed: Oct. 25, 2018

(51) Int. Cl. G07C 5/08; B60C 23/04; B60C 23/00; B60T 17/22

(52) U.S. Cl. CPC G07C 5/08; B60T 17/221; B60C 23/003; B60C 23/0498

(57) ABSTRACT

An electronic monitoring system is attachable to the wheel-end of a wheeled vehicle. The system monitors sensor readings and may analyze the readings to diagnose conditions related to vehicle components, including tires, axles, bearings or components of the monitoring system. The system may analyze readings to predict, or prognosticate, conditions related to vehicle components or to components of the monitoring system.

### RELATED APPLICATIONS

This application claims benefit of U.S. Provisional application entitled, VEHICLE MONITORING, ANALYSIS AND ADJUSTMENT SYSTEM,” Application No. 62/707,265, filed Oct. 26, 2017, which is hereby incorporated by reference in its entirety. This application is being filed on the same date as Applications having the same inventorship as this application and having the titles “APPARATUS AND METHOD FOR VEHICLE WHEEL-END GENERATOR,” “APPARATUS AND METHOD FOR VEHICLE WHEEL-END FLUID PUMPING,” “APPARATUS AND METHOD FOR VEHICULAR MONITORING, ANALYSIS AND CONTROL OF WHEEL-END SYSTEMS,” and “APPARATUS AND METHOD FOR AUTOMATIC TIRE INFLATION SYSTEM” the contents of which are hereby incorporated by reference in their entirety.

### BACKGROUND

Inventive concepts relate generally to a system and method for monitoring and adjusting vehicle characteristics. In particular, inventive concepts relate to a system and method for monitoring, inflating, maintaining tire and wheel related parameters, including air pressure and other parameters, analyzing related data and employing the related data for vehicle operation and maintenance.

Underinflated tires can adversely affect vehicle performance through reduced handling characteristics, lower fuel economy, increased tire wear, road side break downs, etc. However, insuring proper tire inflation is time-consuming and can be a dirty and difficult task. Tire Pressure Monitoring Systems (TPMS) have been proposed as a means of monitoring tire pressure and advising an operator of the state of pressurization in a tire when the pressure is below a target pressure level. Typically, such monitoring systems merely provide an indication of tire pressure inflation level; they do not resolve a tire inflation issue. To address an improper inflation issue, the vehicle must be stationary and proper inflation equipment (both inflation and measuring equipment) must be available, and they often are not.

Although automatic tire inflation systems (ATIS) are available, these systems are costly and difficult to install, particularly for vehicles such as large trucks. Such systems may require specially-ordered attaching equipment, such as custom drive axles. They also, typically, require an extended amount of installation time, making retrofitting an arduous and costly task. These systems do not provide tire status information; they generally maintain targeted tire pressures by pumping air from a reservoir into a tire as the tire's air pressure falls below targeted levels.

### SUMMARY OF THE INVENTION

In example embodiments in accordance with principles of inventive concepts a vehicle monitoring, analysis, and control system may include a wheel-end unit positioned on a wheel-end of a vehicle to generate electrical power, to provide high-frequency sensing and monitoring of wheel-end parameters, to analyze wheel-end health and functionality, to provide real-time control of wheel functions, such as tire inflation and load balancing, to provide communications, for example, among wheel-end units, and to provide expandability of sensing capabilities.

In example embodiments a system may employ a component that rotates relative to the inertial reference frame of a rotating wheel to form what is referred to herein as an inertial power generator. The inertial power generator may generate electrical power for an electronic monitor analysis and control system in accordance with principles of inventive concepts and may provide mechanical power to a mechanical pumping system that provides air to one or more tires associated with a wheel-end. In example embodiments with a system in accordance with principles of inventive concepts attached to a wheel-end, as the vehicle moves a system housing and a portion of internal workings of the system rotate along with the axle and wheel-end with which it is associated. A portion of the system, referred to herein as an inertial electrical power generator, or a portion thereof, does not rotate along with the wheel-end. The differential rotation between the components that rotate along with the wheel-end and the components that do not is employed to generate electrical power. Power conditioning and electrical power storage, such as battery storage, may be employed to provide power to a system processor whether the vehicle associated with the wheel-end is moving or not. While the vehicle moves, power is generated by the inertial power generator; while the vehicle is stationary, power may be drawn from the electrical power storage. In example embodiments mechanical power may be generated through the differential rotation, either in combination with the electrical power or not.

In example embodiments a vehicle monitoring, analysis, and control system in accordance with principles of inventive concepts may provide continuous, high-frequency sampling of wheel-end parameters provided by sensors such as a tire pressure sensor, a tire temperature sensor, accelerometer sensor, audio sensor, or moisture sensor, for example. In example embodiments, the steady availability of power from the inertial electrical power generator enables continuous, high-frequency sampling of the various sensors, which, in turn, enables accurate monitoring, analysis and control of vehicle operations, within each monitoring, analysis, and control system and among a plurality of such systems mounted on an individual vehicle.

In example embodiments a system may perform latitudinal and longitudinal analyses of wheel-end functionality, providing diagnostics and prognostics for a wheel-end and for a vehicle associated therewith. Because Applicants' system generates its own electrical power, electrical power is always available while the vehicle is in motion. Because the system provides electrical energy storage, electrical energy is also available during periods of vehicle idleness. As previously noted, the constant availability of electrical power permits the system to continuously sense, at a high frequency, various vehicle parameters. The collected body of sensor readings allows the system to analyze wheel-end and vehicle performance in a manner far beyond the conventional detection of low tire-pressure. Applicants' system and method may perform extremely complex and accurate analyses in both the time and frequency domain. Frequency analyses may employ Fourier, Gabor, or Wavelet transforms, for example, with machine learning to analyze the state of a vehicle, to diagnose issues, to prognosticate, or predict, potential long-term problems or imminent failures, recommend maintenance or control operations that improve vehicle performance, such as controlling optimum tire inflation and load-balancing. The system's diagnostics may, for example, provide an indication of wheel-end “health” or overall performance of the vehicle, diagnose various issues, extend the lives of tires, of the wheel-end and of the system itself. All of this is directed to improving the overall safety, economy, and endurance of the wheeled vehicle.

In example embodiments a system may employ the system's detailed sensing, analyses, and diagnostics to provide real-time control of wheel-end functions, such as tire-pressure adjustment (raising or lowering the pressure) and load balancing.

In example embodiments a system may include a communications system that allows communications among wheel-end units, between wheel-end units and a vehicle central unit processor and between a wheel-end unit and an off-vehicle monitoring, maintenance and control systems. In this manner, a system may provide constant, real-time diagnostics and prognostics to a vehicle central processor, in a driverless vehicle embodiment, for example, or to remote monitoring and maintenance systems, for example. A sensor complement may include tire pressure, tire temperature, audio sensors, accelerometer, Hall effect sensor and moisture sensors, for example.

In example embodiments a monitoring system for attachment to a wheeled vehicle wheel-end includes a sensor to sense a physical characteristic of a vehicle to which the monitoring system is attached; a controller to collect readings from the sensor; and the controller to employ the sensor readings to analyze operation of the vehicle.

In example embodiments a monitoring system for attachment to a wheeled vehicle wheel-end includes the analysis of sensor readings including trend analysis.

In example embodiments a monitoring system for attachment to a wheeled vehicle wheel-end includes the analysis of sensor readings including the diagnosis of the functionality of the monitoring system.

In example embodiments a monitoring system for attachment to a wheeled vehicle wheel-end includes the analysis of sensor readings including the diagnosis of the functionality of the vehicle.

In example embodiments a monitoring system for attachment to a wheeled vehicle wheel-end includes the diagnoses of the functionality of the vehicle including diagnosing the physical state of a vehicle, such as the pressurization state of a tire associated with a wheel-end to which the monitoring system is attached, alignment of a vehicle axis, brake drag in the vehicle, potential delamination of a tire associated with the vehicle, “out-of-round” or other damage to a wheel on the vehicle, for example. In example embodiments such measurements, analyses and control include measurements and analyses among a plurality of wheel-end units mounted on the same vehicle.

In example embodiments a monitoring system for attachment to a wheeled vehicle wheel-end includes the diagnoses of the functionality of the vehicle includes diagnosing the pressurization state of a plurality of tires associated with a wheel-end to which the monitoring system is attached.

In example embodiments a monitoring system for attachment to a wheeled vehicle wheel-end includes the diagnosis of the functionality of the vehicle including diagnosing the state of an axle associated with the wheel-end to which the monitoring system is attached.

In example embodiments a monitoring system for attachment to a wheeled vehicle wheel-end includes the diagnosis of the functionality of the vehicle including diagnosing the state of bearing associated with the wheel-end to which the monitoring system is attached.

In example embodiments a monitoring system for attachment to a wheeled vehicle wheel-end includes a controller configured to prognosticate, or predict, changes in the vehicle.

In example embodiments a monitoring system for attachment to a wheeled vehicle wheel-end includes a controller configured to predict when a tire associated with the wheel-end to which the monitoring system is attached should be replaced.

In example embodiments a method of a monitoring system for attachment to a wheeled vehicle wheel-end includes a sensor to sense a physical characteristic of a vehicle to which the monitoring system is attached; a controller to collecting readings from the sensor; and the controller employing the sensor readings to analyze operation of the vehicle.

In example embodiments a method of a monitoring system for attachment to a wheeled vehicle wheel-end includes the analysis of sensor readings including trend analysis.

In example embodiments a method of a monitoring system for attachment to a wheeled vehicle wheel-end includes an analysis of sensor readings including diagnosis of the functionality of the monitoring system.

In example embodiments a method of a monitoring system for attachment to a wheeled vehicle wheel-end includes the analysis of sensor readings including the diagnosis of the functionality of the vehicle.

In example embodiments a method of a monitoring system for attachment to a wheeled vehicle wheel-end includes the diagnoses of the functionality of the vehicle including diagnosing the pressurization state of a tire associated with a wheel-end to which the monitoring system is attached.

In example embodiments a method of a monitoring system for attachment to a wheeled vehicle wheel-end includes the diagnoses of the functionality of the vehicle including diagnosing the pressurization state of a plurality of tires associated with a wheel-end to which the monitoring system is attached.

In example embodiments a method of a monitoring system for attachment to a wheeled vehicle wheel-end includes the diagnoses of the functionality of the vehicle including diagnosing the state of an axle associated with the wheel-end to which the monitoring system is attached.

In example embodiments a method of a monitoring system for attachment to a wheeled vehicle wheel-end includes the diagnosis of the functionality of the vehicle including diagnosing the state of bearing associated with the wheel-end to which the monitoring system is attached.

In example embodiments a method of a monitoring system for attachment to a wheeled vehicle wheel-end includes a controller to prognosticating, or predicting, changes in the vehicle.

In example embodiments a method of a monitoring system for attachment to a wheeled vehicle wheel-end includes a controller predicting when a tire associated with the wheel-end to which the monitoring system is attached should be replaced.

### BRIEF DESCRIPTION OF THE DRAWINGS

Example embodiments in accordance with principles of inventive concepts will be more clearly understood from the following detailed description taken in conjunction with the accompanying drawings in which:

FIG. 1 is a block diagram of an example embodiment of an electronic system that may employ one or more vehicle monitoring, analysis, and control systems in accordance with principles of inventive concepts;

FIG. 2 is a block diagram of an example embodiment of a vehicle monitoring, analysis, and control system in accordance with principles of inventive concepts;

FIGS. 3-4B are views of example embodiments of vehicle monitoring, analysis and control systems installed on vehicles;

FIG. 5 is a front view of an example embodiment of a vehicle monitoring, analysis and control system mounted on a wheel-end;

FIG. 6 is an exploded view of an example embodiment of energy harvesting components of a vehicle monitoring, analysis and control system;

FIG. 7 is an isometric view of an example embodiment of a quasi-stationary element of an energy harvesting component of a vehicle monitoring, analysis, and control system;

FIG. 8 is an exploded view of an example embodiment of an energy harvesting components such as may be employed in a vehicle monitoring, analysis, and control system;

FIG. 9 is a block diagram of an example embodiment of electrical elements of a vehicle monitoring, analysis, and control system;

FIG. 10 is a more detailed block diagram of an example embodiment of electrical elements of a vehicle monitoring, analysis, and control system;

FIG. 11 is a block diagram of an example embodiment of electronic control elements of a tire pressurization component such as may be employed by a vehicle monitoring, analysis and control system;

FIG. 12 is a flow chart of an example embodiment of training a classifier for use in a vehicle monitoring, analysis and control system; and

FIG. 13 is a flow chart of an example embodiment of a vehicle monitoring, analysis and control system employing a classifier for analysis of vehicle-related sensor readings.

### DETAILED DESCRIPTION

Example embodiments in accordance with principles of inventive concepts will now be described more fully with reference to the accompanying drawings, in which example embodiments are shown. Example embodiments in accordance with principles of inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. Like reference numerals in the drawings denote like elements, and thus their description may not be repeated. Example embodiments of systems and methods in accordance with principles of inventive concepts will be described in reference to the accompanying drawings and, although the phrase “example embodiments in accordance with principles of inventive concepts” may be used occasionally, for clarity and brevity of discussion example embodiments may also be referred to as “Applicants' system,” “the system,” “Applicants' method,” “the method,” or, simply, as a named component or element of a system or method, with the understanding that all are merely example embodiments of inventive concepts in accordance with principles of inventive concepts.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “or” includes any and all combinations of one or more of the associated listed items. Other words used to describe the relationship between elements should be interpreted in a like fashion (for example, “between” versus “directly between,” “adjacent” versus “directly adjacent,” “on” versus “directly on”). The word “or” is used in an inclusive sense, unless otherwise indicated.

It will be understood that, although the terms “first”, “second”, etc. may be used herein to describe various elements, components, regions, layers or sections, these elements, components, regions, layers or sections should not be limited by these terms. These terms are only used to distinguish one element, component, region, step, layer or section from another element, component, region, step, layer or section. Thus, a first element, component, region, step, layer or section discussed below could be termed a second element, component, region, step, layer or section without departing from the teachings of example embodiments.

Spatially relative terms, such as “beneath,” “below,” “lower,” “above,” “upper,” “top,” “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if an element in the figures is turned over, elements described as “bottom,” “below,” “lower,” or “beneath” other elements or features would then be oriented “atop,” or “above,” the other elements or features. Thus, the example terms “bottom,” or “below” can encompass both an orientation of above and below, top and bottom. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” or “including,” if used herein, specify the presence of stated features, integers, steps, operations, elements or components, but do not preclude the presence or addition of one or more other features, integers, steps, operations, elements, components or groups thereof. The word “or” is used in an inclusive sense to mean both “or” and “and/or.” The term “exclusive or” will be used to indicate that only one thing or another, not both, is being referred to.

Unless otherwise defined, all terms (including technical and scientific terms) used herein have the same meaning as commonly understood by one of ordinary skill in the art to which example embodiments in accordance with principles of inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

For clarity and brevity of description, inventive concepts may be described in terms of example embodiments related to large trucks. Although the following example embodiments focus on examples within the realm of large trucks, other wheeled vehicles, such as off-road vehicles, lift-trucks, industrial trucks, mining vehicles, automobiles, buses, in fact, any wheeled vehicle, are contemplated within the scope of inventive concepts.

The terms first, second, third, etc. may be used herein to describe various elements, components, regions, layers or sections. These elements, components, regions, layers or sections should not be limited by these terms. These terms may be only used to distinguish one element, component, region, step, layer or section from another region, step, layer or section. Terms such as “first,” “second,” and other numerical terms do not imply a sequence or order unless clearly indicated by the context. Thus, a first element, component, region, step, layer or section discussed below could be termed a second element, component, region, step, layer or section without departing from the teachings of the example configurations.

A vehicle monitoring, analysis, and control system in accordance with principles of inventive concepts may include a wheel-end unit positioned on a wheel-end of a vehicle to generate electrical power, to provide high-frequency sensing and monitoring of wheel-end parameters, to analyze wheel-end health and functionality, to provide real-time control of wheel functions, such as tire inflation and load balancing, to provide communications, for example, among wheel-end units, and to provide expandability of sensing capabilities.

In example embodiments a system in accordance with principles of inventive concepts may employ a component that rotates relative to the inertial reference frame of a rotating wheel to form what is referred to herein as an inertial power generator. The inertial power generator may generate electrical power for an electronic monitor analysis and control system in accordance with principles of inventive concepts and may provide power to a mechanical pumping system that provides air to one or more tires associated with a wheel-end. With a system in accordance with principles of inventive concepts attached to a wheel-end, as the vehicle moves a system housing and a portion of internal workings of the system rotate along with the axle and wheel-end with which it is associated. A portion of the system, referred to herein as an inertial electrical power generator, or a portion thereof, does not rotate along with the wheel-end. The differential rotation between the components that rotate along with the wheel-end and the components that do not is employed to generate electrical power. Power conditioning and electrical power storage, such as battery storage, may be employed to provide power to a system processor whether the vehicle associated with the wheel-end is moving or not. While the vehicle moves, power is generated by the inertial power generator; while the vehicle is stationary, power may be drawn from the electrical power storage.

A vehicle monitoring, analysis, and control system in accordance with principles of inventive concepts may provide continuous, high-frequency sampling of wheel-end parameters provided by sensors such as a tire pressure sensor, a tire temperature sensor, accelerometer sensor, audio sensor, or moisture sensor, for example. In example embodiments, the steady availability of power from the inertial electrical power generator enables continuous, high-frequency sampling of the various sensors, which, in turn, enables accurate monitoring, analysis and control of vehicle operations.

Applicants' system may perform latitudinal and longitudinal analyses of wheel-end functionality, providing diagnostics and prognostics for a wheel-end and for a vehicle associated therewith. Because Applicants' system generates its own electrical power, electrical power is always available while the vehicle is in motion. Because the system provides electrical energy storage, electrical energy is also available during periods of vehicle idleness. As previously noted, the constant availability of electrical power permits the system to continuously sense, at a high frequency, various vehicle parameters. The collected body of sensor readings allows the system to analyze wheel-end and vehicle performance in a manner far beyond the conventional detection of low tire-pressure. Applicants' system and method may perform extremely complex and accurate analyses in both the time and frequency domain. Frequency analyses may employ Fourier, Gabor, or Wavelet transforms, for example, with machine learning to analyze the state of a vehicle, to diagnose issues, to prognosticate, or predict, potential long-term problems or imminent failures, recommend maintenance or control operations that improve vehicle performance, such as controlling optimum tire inflation and load-balancing. The system's diagnostics may, for example, provide an indication of wheel-end “health” or overall performance of the vehicle, diagnose various issues, extend the lives of tires, of the wheel-end and of the system itself. All of this is directed to improving the overall safety, economy, and endurance of the wheeled vehicle.

Applicants' system may employ the system's detailed sensing, analyses, and diagnostics to provide real-time control of wheel-end functions, such as tire-pressure adjustment (raising or lowering the pressure) and load balancing.

Applicants' system may include a communications system that allows communications among wheel-end units, between wheel-end units and a vehicle central unit processor and between a wheel-end unit and an off-vehicle monitoring, maintenance and control systems. In this manner, a system may provide constant, real-time diagnostics and prognostics to a vehicle central processor, in a driverless vehicle embodiment, for example, or to remote monitoring and maintenance systems, for example.

A sensor complement may include tire pressure, tire temperature, audio sensors, accelerometer, Hall Effect sensor and moisture sensors, for example.

A wheel-end unit may communicate directly with other wheel-end units associated with the same vehicle, may communicate with other wheel-end units through an intervening hub, or may communicate with other wheel-end units through other communications channels, such as through the cloud. In example embodiments each wheel-end unit includes a controller that may detect accelerometer data to determine from vibration signatures whether the associated wheel is out-of-round by comparing the vibrational signature to the vibrational signature of wheels that are not out of round or by comparing the vibrational signature to the vibrational signature of wheels that are our of round. In example embodiments a wheel-end unit may compare measurements from axle to axle on the same vehicle to determine whether an associated axle is out of alignment (for example, if one wheel turns at a higher rate than another or) or brake dis-function (for example, brake drag or other failure) by comparing wheel rotation rates, temperature, and rate of change, for example. Tire failures, such as impending delamination or bulges, for example, may be determined by comparing wheel-end signatures (based upon sensor data, such as vibration, temperature, and pressure) with example wheel-end signatures that either exhibit such imminent failures (e.g., known bad) or do not exhibit such failures (known good). Such comparisons may also compare signatures from other wheel-end units associated with the same vehicle.

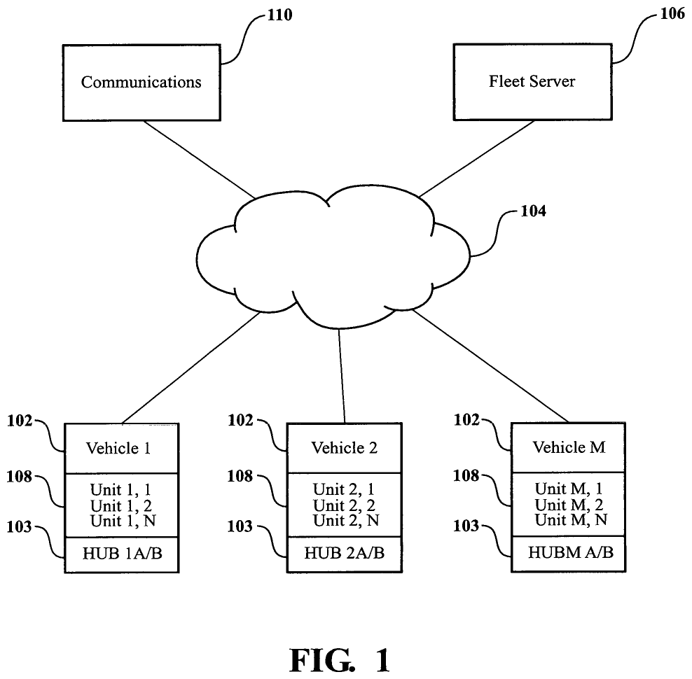

An example embodiment of a vehicle monitor, analysis, and control system 100 in accordance with principles of inventive concepts is illustrated in the block diagram of FIG. 1. In this example embodiment M vehicles 102 each include N wheel-end unites 108. The trailer of a semi-trailer truck may include four wheel-end units, one for each dual-tire wheel-end, and the cab may include four, one for each wheel-end, for a total of eight wheel-end units 108 for each semi-trailer/cab combination.

As previously indicated, system 100 and wheel-end units 108 may be used in conjunction with any wheeled vehicle, whether off-road, commercial, industrial, or passenger. Descriptions herein will be directed to use with large trucks, but inventive concepts are not limited thereto.

Each wheel-end unit 108 includes a communications system including a transceiver that may provide communications using any of a variety of technologies and formats, including any wireless communications link such as Bluetooth, WiFi, RFID, infrared, visible or radio-frequency. Each wheel-end unit 108 may include a transceiver that allows the wheel-end unit to communicate with each of the other wheel-end units associated with the same vehicle it is associated with. Each vehicle (the term vehicle includes motorized vehicles, such as a semi-trailer cab and non-motorized vehicles, such as a semi-trailer trailer, for example) may include a hub 103 that may provide communications with all wheel-end units associated with the vehicle and may provide communications, through cloud 104, for example, with one or more fleet servers 106 or one or more portable communications devices 110, which may be a laptop computer, a pad computer, or a cellular telephone, for example. Hub 103 may provide vehicle control functions, such as for controlling an autonomous or remote-controlled vehicle, for example. Fleet server 106 may gather diagnostics and prognostic analysis results provided by one or more wheel-end units 108 and, at least in part, from those results may coordinate maintenance or replacement of vehicle systems or components. Each hub 103 may be associated with a trailer or cab and, in a semi-trailer truck embodiment, the combined vehicles (i.e., trailer and cab) may include two hubs 103, one each for the cab and trailer, or one hub 103 may service both the cab and trailer.

In some embodiments wheel-end units 108 may communicate directly with fleet server 106 through cloud 104 and may include an Internet interface, allowing fleet server 106 or portable communications device 110 to access raw data or analytics (e.g., diagnostics and prognostics) from each wheel-end unit 108, either directly or through hub 103. Diagnostics and prognostics may employ, for example, a frequency domain analysis of nearest-neighbor tires (e.g., tires on the same end of an axle or those on opposing ends of the same axle). Such analysis may be used to determine whether wheels are out of alignment, whether a tire has been damaged, whether road hazards, such as pot-holes or road debris had been encountered, whether other impact events had occurred, whether foreign objects may have become lodged within a tire, or whether tread delamination had begun, for example. Data may be employed, for example, to build or improve models for improved analytics. Tire wear and aging or deterioration of tires may also be detected through analysis in example embodiments. In some embodiments hub 103 may gather, organize and format raw data and analytic results from an associated vehicle for presentation to fleet server 106 or portable communications device 110.

A vehicle monitoring, analysis, and control system in accordance with principles of inventive concepts may be attached to a vehicle's wheel-end to monitor and adjust, for example, the air pressure of a tire associated with the wheel-end to which the system is attached. A plurality of such systems may be employed on a vehicle, with individual systems attached to each vehicle wheel-end. In example embodiments a system in accordance with principles of inventive concepts may include an inertial power generator, a mechanical pumping system and an optional electronic control and communication system. Because the system is attached to a wheel-end, as the vehicle moves the housing and a portion of internal workings of the system rotate along with the axle and wheel-end with which it is associated. A portion of the system, referred to herein as an inertial power generator, or a portion thereof, does not rotate along with the wheel-end.

In example embodiments the inertial power generator includes a quasi-stationary element (also referred to herein as a stationary element) in the form of a weighted pendulum, which is supported by a shaft along a central axis of the system and is free to rotate thereabout. A mechanical coupler (also referred to herein as a transmission system, or, simply, a transmission) couples the quasi-stationary element to the pumping system, which, along with the transmission, rotates with the rotation of the vehicle's wheel. With the coupling and pumping system rotating and the pendulum substantially stationary, the pendulum applies a torque to the transmission, which transfers the torque to the pumping system. In example embodiments, the weighted pendulum is configured to supply sufficient torque to meet demands. That is, the pendulum is sized to, at one extreme, provide sufficient weight that the pendulum would always remain quasi-static (never move) under torque demands of the system, and at the other extreme, be just a bit more than a mass that would cause the pendulum to spin under a torque demand situation, making the system ineffective. The minimum weight of the pendulum must be sufficiently large to drive the systems within the monitoring, analysis and control system accounting for multiple demands including: pumping, meeting other torque demands of the system (e.g. electrical power generation, start-up torques due to inertia, friction; starting vs. running, etc.), possible parasitic loss developments over the life of the system, as well as a performance margin (safety margin). As noted, the pendulum will have demands that are larger than the steady state running torques and these peak torques will drive the sizing of the pendulum mass. The running torques will fluctuate to some degree, as well. The design of the overall system has been structured to minimize the torque requirements. The system is structured to minimize the torque requirements by minimizing of drive torques, while not violating minimum pumping requirements. This may include gear drive ratios other than 1:1, possibly using a 2:1 average gear ratio, or similar type ratio between the drive gear and the driven gear. Additionally, to address the fluctuating torque demands, use of a unique torque transmission system using an elliptical gear system to provide added mechanical advantage at the point of highest compression of the compressor thus reducing fluctuation in the system peak torque demands. A lighter pendulum mass is beneficial in both the weight saving from the mass reduction of the pendulum itself, as well as, the benefits of lowered bearing and structural loading requirements associated with the lower pendulum mass. This translates into improved durability at a lower weight and allowing the collective weight saved to be applied in the transfer of added vehicle cargo.

In example embodiments, the electrical system may include a power source in the form of a primary or secondary battery. In example embodiments in which a secondary battery is used, the electrical system may employ an electrical generator that is coaxial with a system support, with the generator's stator coupled to the system support (thereby rotating with the rotational portion of the system) and the rotor is coupled to the pendulum, thereby remaining substantially stationary; the relative rotation between the stator and rotor generates electricity. Electricity thus-generated may be used by electronics directly (with normal conditioning) or supplied to an electrical storage system, such as a secondary battery. In embodiments in which a primary batter is used, the battery supplies power to the electronics directly and is replaced as needed.

As will be described in greater detail below, the electrical system may include a variety of sensors that are monitored by a controller (such as a microcontroller, for example). The controller obtains data from various sensors and processes the data. The processed data may be stored, analyzed and transmitted. The results of analyses may be used by the controller to control the pumping system in order to inflate an associated vehicle tire, for example or may generate recommended actions, that may be either immediate in nature or of a maintenance ongoing nature associated with the state of the wheel-end, axle system or trailer/tractor in total. This information may be transmitted to the driver or a third party using any of a variety of methods.

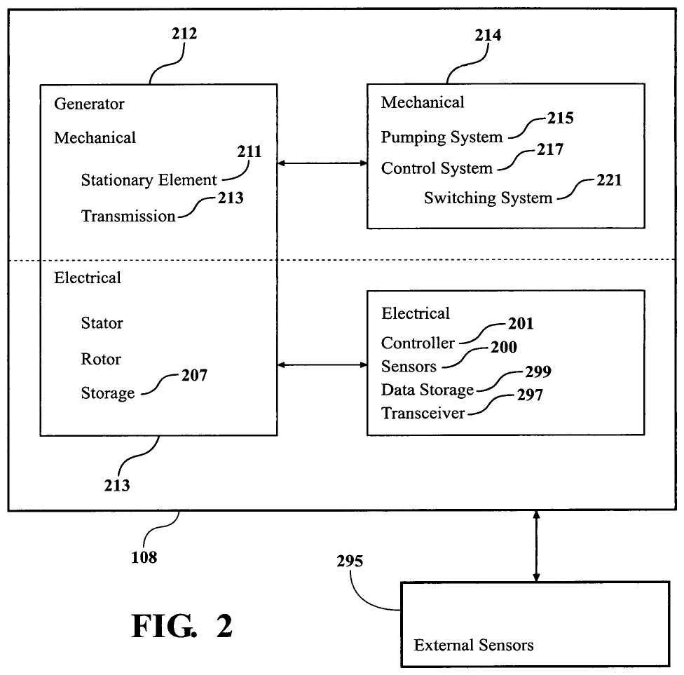

The conceptual block diagram of FIG. 2 provides an overview of an example embodiment of a vehicle monitoring and adjustment system wheel-end unit 108 in accordance with principles of inventive concepts. System wheel-end unit 108 includes a mechanical power generator 212, a mechanical system 214, and electrical power generator 213 an electrical system 216, all of which may be mounted to a vehicle's wheel-end.

Power generator 212 includes quasi-stationary element 211 (a weighted pendulum in example embodiments), which is supported along a central axis of the system on a system support shaft and is free to rotate thereabout. Although free to move about the axis of a shaft, quasi-stationary element 211 remains substantially stationary in its own reference frame, while rotating about the shaft in the reference frame of a substantial portion of the system wheel-end unit 108. Quasi-stationary element 211 may also be referred to herein as stationary element or pendulum, for example. Transmission 213 couples pendulum 211 to mechanical pumping system 215 and mechanical switching system 221, which, along with transmission 213, rotates along with the rotation of the vehicle's wheel.

With the transmission 213 and pumping system 215 rotating and pendulum 211 substantially stationary, the pendulum 211 applies a torque to the transmission 213, which transfers the torque to pumping system 215. The mass size and configuration, and the lever arm length of pendulum 211 are chosen to deliver sufficient torque for pump, and electrical generation actions through a wide range of a vehicle's operating speeds, without excessive travel of the pendulum. In example embodiments power generator 212 includes an electrical generator 213 and electrical storage 207 (also referred to herein, simply, as a “battery”), used to power electrical system 216. In example embodiments, electrical generator 213 is coaxial with a system support shaft, with the generator's stator 205 coupled to the system support (thereby rotating with the rotational portion of the system) and the generator's rotor 203 is coupled to the pendulum 211, thereby remaining substantially stationary; the relative rotation between the stator 205 and rotor 203 generates electricity.

Mechanical system 214 includes mechanical control 217 (including mechanical switching 221), pumping 215, and filtration 219, each of which will be described in greater detail below. Mechanical control system 217 engages transmission 213 with pendulum 211 within a range of operational parameter values and disengages transmission 213 from pendulum 211 outside that range. Pumping system 215 translates rotational movement provided by transmission 213 into linear movement used to operate pistons that compress air for use in maintaining proper tire pressure.

Electrical system 216 may include a controller 201, which may be embodied as microcontroller, or microprocessor and various support electronics, for example. Controller 201 may obtain data from a variety of sensors 200 and operate upon the data for a variety of analytical, control, storage, and transmission functions, as will be described in greater detail below. These sensors may include sensors internal to the monitoring, analysis and control system unit as well as those that may be external to the unit, sensors 295.

The availability of an electrical power generating source within the system affords the opportunity to perform many functions not available with a fixed electrical source that needs to conserve energy. Examples include the ability to sample sensors at much higher rates and for much longer durations than would typically be done in a battery-powered system. Additionally, the presence of a powerful processor, such as a microcontroller (MCU), or System-On-Chip (SOC) within the unit, allows the ability to perform intensive signal processing functions. As an example, sampling of accelerometer data at 16 KHZ can be performed continuously while performing Fast Fourier Transforms (FFT's) or Discrete Fourier Transforms (DFT's) via a 32-Bit MCU on the resulting signals, allowing the gathering of not only accelerometer magnitudes, which indicate things such as pot hole events, but also frequency information which are only available via much more power demanding operations that the aforementioned on-board processor can perform. In some embodiments, the system 108 may employ this data to perform analytics to provide diagnostics and prognostics heretofore unavailable.

For example, the system 108 may sample raw 10-bit or 12-bit data over long intervals (for example, at least one second recordings) at very fast rates (for example, at a minimum of 16 KHZ) to generate a sample file of the accelerometer recording of events that contain an array of precisely timed sensor readings. In this manner, system 108 may extract frequency domain data, rather than, or in addition to, just time domain data. By extracting frequency domain data, system 108 derives the data necessary for it to provide a significantly greater degree of signal processing capabilities, up to and including machine learning processes. With system 108 including a continuous internal power generating source 213, the system may sample numerous sensors, continuously and at a high rate. In example embodiments sampling resolution may most commonly fall within the 8-bit to 24-bit range, for example, with 12-bit resolution most common. Sampling frequency may be determined by a specific sensor's throughput capability, or update rate, but, generally, sampling is done at or above the Nyquist rate for a given sensed characteristic. For example, sampling frequency may be from 1 Hz for relatively slow-changing characteristics to the maximum capabilities of a system controller or sensor output capability. In example embodiments, a sampling rate of from 1 Hz to 16 kHz would be adequate to address many characteristics of interest, such as vibrational characteristics, which are typically manifested within a range of up to 8 kHz. Higher rates may be employed, for example, to sample vibrations within the audible range (for example, sampling at 40 kHz provides loss-free sampling for vibrations up to 20 kHz, the commonly accepted upper limit of the audible range). However, inventive concepts are not limited thereto.

The use of a main processor, controller 201, housed within wheel-end unit 108, allows sampling and analysis at high rates and to the fullest capabilities. Along with this, system 108 performs continuous monitoring and analysis of a variety of functions, components, and performances could generally be described as “wheel-end health.” Such operations may include, for example, monitoring wheel imbalance, which the system 108 detects via frequency domain readings of the accelerometer sensors; comparing the frequency domain results of one wheel, say wheel “A”, to the frequency results of a second wheel, say wheel “B.” Such a comparison, performed by system 108, allows system 108 to better discriminate between environmental effects, such as a bumpy road condition, that all tires may be experiencing, and single events that only one wheel may experience, such as damaging a tire from hitting a curb or pot hole. The processing capabilities of an always-powered system, recording at very high data rates, over long periods of time, and the ability of the wheel-ends to communicate with each other and share their data, allow the creation of a very powerful wheel-end health monitoring system with diagnostic and prognostic capabilities at each wheel-end, assessing performance for wheel-ends, extending to axle assemblies and units in total (e.g. axle alignment, etc.).

The performance and capabilities of a wheel-end unit system 108 may extend beyond the confines of the monitoring, analysis and control system. Sensors 295 may exist external to the monitoring, analysis and control system and utilize the computing power of the monitoring, analysis and control system in assessing the status and health of the environment in the vicinity of the monitoring, analysis and control system and around the vehicle in total. For example, external sensors 295 may include brake system slack adjuster sensors. Such sensors may monitor the performance of a brake system slack adjuster and, as the brake system slack adjuster continually adjusts the brake system as the pads wear and moves into an area that may require vehicle maintenance, the monitoring, analysis and control wheel-end unit system 108 may communicate that knowledge to the appropriate personnel in an appropriate time frame to allow maintenance prior to field issues occurring. For example, a system in accordance with principles of inventive concepts may issue a warning to prevent tire delamination when delamination may be imminent (as indicated by sensor readings and analyses). Such a warning would be particularly beneficial while the vehicle is moving, as delamination can damage the vehicle with the delaminating tire and surrounding vehicles, as well. As noted elsewhere, in example embodiments, a monitor, analysis and control system includes an air-compressor and air filter. By monitoring air filter performance, a system may determine the extent of air compressor wear.

Additionally, in example embodiments, a system may monitor the temperature of a generator, or energy harvester, in accordance with principles of inventive concepts to analyze any aging issues that may expressed through temperature and, should aging become an issue, indicate that the generator should be replaced.

An additional example embodiment of the use of external sensors 295 by system 108 may include suspension ride height sensors. These sensors may indicate the ride height of a trailer system and system 108, from the ride height, system 108 may calculate the weight and placement of load within the trailer. In some embodiments system 108 employs data collected from all of the wheel-end unit systems 108 associated with a trailer are analyzed by one or more of the systems 108 calculating the center of gravity within the trailer unit. Having determined the weight and displacement of load within a trailer, in some embodiments system 108 may optimize tire pressure, based upon load conditions (for example, higher pressures for heavier loads and vice versa). In some embodiments, system 108 may also assess and provide recommendations for load placement during the loading process or assess potential load shifts during transit. If system 108 determines that a load has shifted, it may alert a driver or manager, either through an optional local user interface (for example, a display and voice, keyboard, keypad, or soft keypad input) or through the cloud 104 to fleet server 106 or portable communications 110 link previously described. Analysis and control using additional types of external sensors, including pressure, temperature, moisture, sound, light level, air filter performance, etc., are contemplated within the scope of inventive concepts.

Data storage 299 may be used to store raw or processed data, analytical results, or data or commands received from other controllers associated with a vehicle or from a separate, possibly centralized, data source, such as a vehicle data center or fleet server 106. Electronic communications may be implemented through transceiver 297 and may allow a system in accordance with principles of inventive concepts to share data and analyses among a plurality of systems or other electronic devices, including a vehicle operator's electronic system, a vehicle dispatcher, or a maintenance manager, for example.

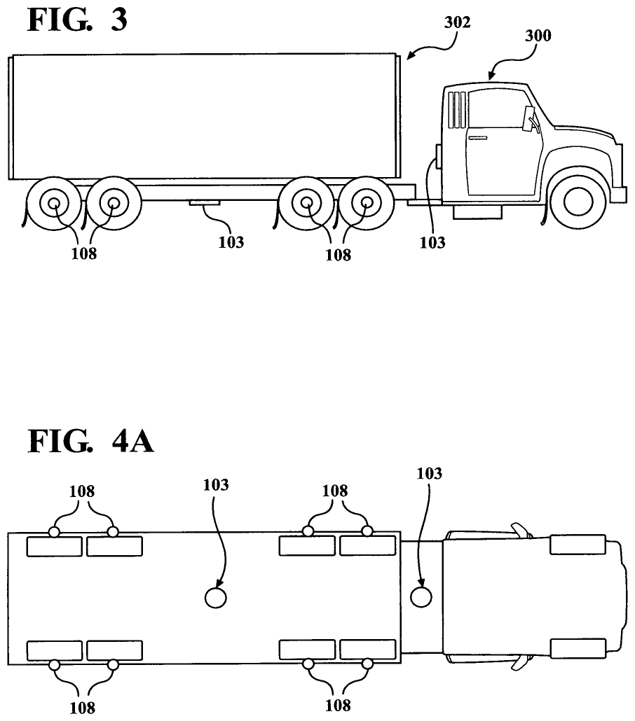

FIG. 3, illustrates, in side view, a plurality of vehicle wheel-end systems 108 in accordance with principles of inventive concepts configured on a vehicle 300. In this example embodiment, the systems 108 are mounted on motored vehicles 300 or trailered units 302 (a tractor 300 and semi-trailer 302 in this example embodiment). The wheel-end systems 108 are shown installed on all powered and trailered (non-powered) wheel assemblies, though a combination of installed and not installed on some wheel assemblies is contemplated within the scope of inventive concepts (for example, installed on powered axles only, or installed on trailered (non-powered) axles only, or installed on a combination of both trailered (non-powered) and powered wheels or as depicted in the illustration). The systems 108 are installed on wheel-ends and provide a distributed set of vehicle monitoring, analysis, and control systems that, among other things, provide tire pressure monitoring and automatic tire inflation.

In example embodiments, each system 108 may operate autonomously to monitor and adjust vehicle attributes, such as tire pressure, associated with the wheel-end to which they are attached. Additionally, each system 108 may store, process, analyze and transmit or receive information (that is, raw data, analytical results or commands, for example) associated with the wheel-end to which they are attached. Such information may be shared with a central processor, or hub, 103 connected to, or associated with, a vehicle (located in either tractor 300 or trailer 302, for example) or one of the systems 108 may operate as a central processor or hub. Each wheel-end system 108 may provide vehicle monitoring, analysis, and control, including, for example, tire pressure monitoring and pressure adjustment for both single and multiple tire combinations as might be configured on a given wheel-end.

Hub 103 may forward sensed, calculated, or analyzed information generated and/or obtained at the monitoring, analysis and control systems 108 to vehicle operators or logistics/maintenance providers as is instructed or designated by the communications controller 103, and as previously described.

FIG. 4a is a plan view, schematic representation displaying monitoring, analysis and control system systems 108 on both motored 300 and trailered (non-powered) 302 vehicles. (FIG. 4b depicting a similar passenger vehicle representation). A hub unit (103) may be positioned on the motored vehicle 300 or on the trailered vehicle 302. The transmitter/receiver unit (103) may communicate between the individual or collective wheel-end, or, monitoring, analysis and control, systems 108 with the world external to systems 108, for example, as determined by preset protocols defined during the set-up of the system. Programmable system parameters may include, but are not limited to: alert notifications, including the type of item to alert, what person/entity to notify; system parameter settings, including tire pressure setting, security setting (e.g. password, type of unauthorized removal actions, etc.); and systems to activate, including system performance monitoring, diagnostic systems, prognostic systems, for example. In example embodiments, the programing/set-up of the monitoring, analysis and control system systems 108 may be performed via a base unit or, for example, via an application as installed on a portable device 110 such as a smart phone.

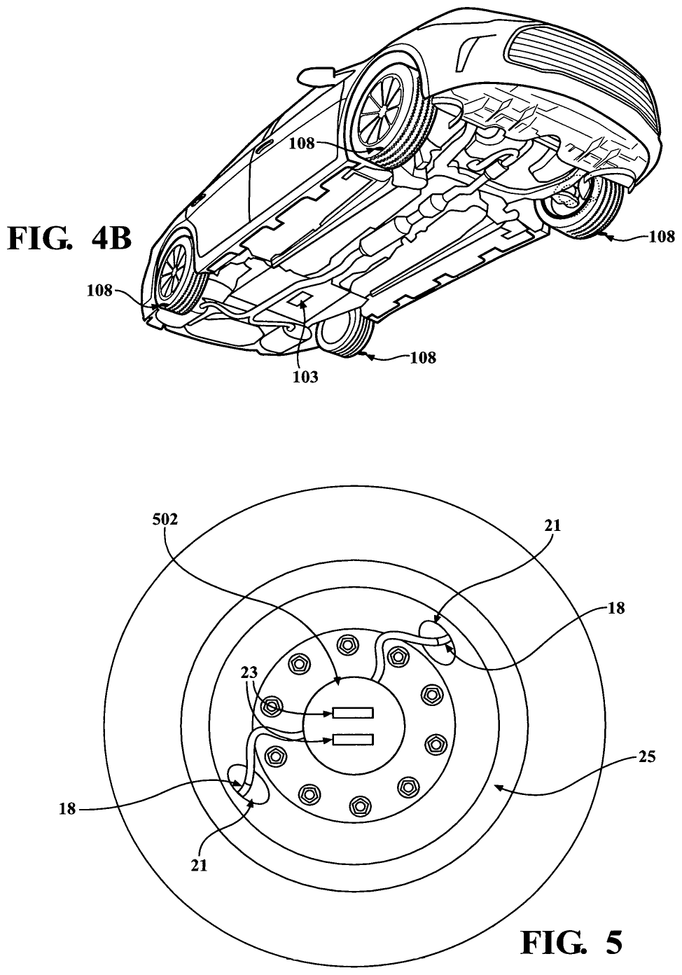

FIG. 5 is a close-up view of an example embodiment of a system 108 in accordance with principles of inventive concepts fixed to a wheel 25. The system 108 may provide connection to a reservoir or plurality of reservoirs 20 or connection to a tire 19 or plurality of tires, which may be made through separate fluid transmission devices. These fluid transmission devices may be tubes, hoses (“hose,” 18 as depicted in the FIG. 5 and as referred to hereinafter), or other types of fluid transfer devices connecting system 108 to the outer and inner tires 19a, 19b (illustrated on the rear tires of trailer 302 in FIG. 4a, for example) by way of the air inlet port or valve 21 on each of the tires. The system 108 end of the hose 18 may connect to ports 22 on system 108. The ports 22, in turn, may be connected to controls or sensors within system 108 that may monitor or adjust the air pressure of the tires if the system 108 detects parameter values outside of targeted value ranges, for example. In example embodiments, the tire health monitoring and parameter-altering may be carried out while the vehicle is in motion and does not require the vehicle to be brought to a stop for either the monitoring or the parameter adjustment to occur.

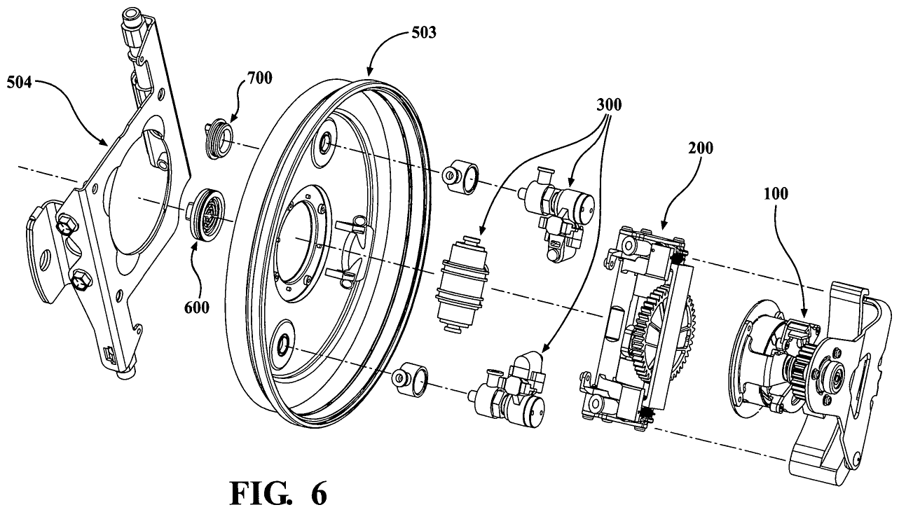

FIG. 6 is an exploded view of mechanical components of an example embodiment of a system 108 in accordance with principles of inventive concepts that. The exploded view depicts several component systems of or within the system 108 (electrical/electronic components and their operations will be described in greater detail elsewhere). A Housing and Mounting System 500 may include a top cover 502 and a bottom cover 503 that encompass the inner working of the system 108 elements. A retaining member 501 may hold the components in place. The retaining member 501 may provide a means of securing the two covers together in a compact manner and may also provide a means of insuring system tamper resistance, for example. The construction of the retaining member 501 may be such that once secured to the two outer covers 502 and 503, removal of the retaining member 501 may require severing (destruction) of the retaining member 501, thereby denying access to the system's 108 inner workings to anyone other than the manufacturer of the unit or other authorized personnel.

Collectively, the three members: bottom cover 503, top cover 502 and retaining member 501, may provide shielding for the system 108 internal components and systems from exposure to the external elements. The enclosure may contain a lubricant which may be of liquid or powder form, for example. In example embodiments, the rotation of system 108 (as an associated wheel rotates), as well as the operational performance of the elements within the system 108, may provide for the distribution of the lubricating material within the assembly. Such lubricant may provide a low-friction surface on relative-motion contacting members, lowering operating friction and reducing associated surface wear or improving system durability.

The top cover 502, in addition to being part of the system 108 enclosure, may also have mounted onto its outer surface solar cells. The solar cells may be connected to the electrical system within system 108 and may provide supplemental power to system 108, particularly when the vehicle is stationary or when system 108 may be demanding power supply in excess of the system's 108 main electrical power generation capability. The top cover 502 may also have mounted into its surface one or more clear areas, which may be used to display the state of inflation of each associated tire. As previously indicated, a user interface may include, for example, input and output, such as audio input and output, displays, keypad entry for communications with authorized personnel.

The bottom cover 503 may provide the means of attaching or retaining the overall system 108 to the wheel hub via attachment to the intermediate attaching bracket 504, using bolts 505 and fastening nuts 506 or other fastening means. The intermediate attaching bracket 504 may attach to the wheel mounting bracket 506 using, for example, bolts 507. The wheel mounting bracket 506 may provide attachment of system 108 to a wheel using the wheel's attaching studs and nuts (not shown).

In example embodiments, the lower cover 503 may have attached within it a housing magnet 512 and a magnetic trigger pairing sensor 514. The wheel mounting bracket 506 may have a wheel mounting bracket magnet 513 attached to the attachment of system 108, including the attaching bracket 504, to the wheel mounting bracket 506 may yield a magnetic pairing of a housing magnet 512 to a wheel mounting bracket magnet 513. The aligning or pairing of these magnets may activate a signal that is detectable by a magnetic trigger pairing sensor 514. Such a device may be used to detect authorized/unauthorized removal of system 108 from the vehicle. Authorized removal may occur through the activation of an authorization code via the base unit, smart phone, or other authorized data submission method, for example. The code will advise the unit to expect an unpairing of the magnets. Should an unauthorized system 108 removal be detected, a system in accordance with principles of inventive concepts may respond in a variety of manners, including, but not be limited to: disabling system 108 and not allowing functionality, setting all ports to discharge, which may result in the system not maintaining pressure and sending alerts to pre-defined entities indicating that the system 108 is being/has been removed, for example.

The intermediate bracket 504 may also provide attachment and positioning for hose fitting 508 or other type fluid transfer fitting. Hose fitting 508 may provide an interface between the air/fluid transfer system within system 108 and the hose assembly 18, which, in turn, may provide one of a variety of connections from system 108 to the tire pressure valve 21. In example embodiments, fitting 508 may have a threaded end compatible with a threaded fitting on the hose assembly 18 and may be securely attached to the hose assembly and the lower cover 503, thereby providing an air-tight fluid conveyance from system 108 to tire valve 21. The lower housing may also provide attachment for air filtering system and a battery system 700.

In example embodiments in accordance with principles of inventive concepts an electrical storage device may be employed to store electrical energy for operation of a system's 108 controller or other electrical components. In example embodiments, the electrical storage device may be a battery (either rechargeable or non-rechargeable) or other electrical storage devices such as capacitors, flywheels, or super-capacitors, for example. The electrical storage devices (also referred to herein, simply, as battery) may be used solely or as a supplement to electrical power generated by system 108 to provide power for elements of system 108 when the system's electrical generator is not generating power or when system power demands exceed the levels of power being generated by system 108's electrical generator. For example, a battery may be used to power control circuitry when the vehicle and system 108 are stationary or traveling at very low speeds (and, therefore, the system's electrical generator is not operating at its full capacity) to allow monitoring of system health and to provide other low-power system functionality.

It may be desirable from time to time to remove the battery assembly to allow for the removal or replacement of the battery. In example embodiments, the battery housing may be configured for removal from the system 108 by a rotational or similar movement of the battery housing relative to a stationary lower cover. A quarter turn and rearward extraction motion of the battery assembly relative to the lower cover may be one such means of removal or replacement of the battery assembly.

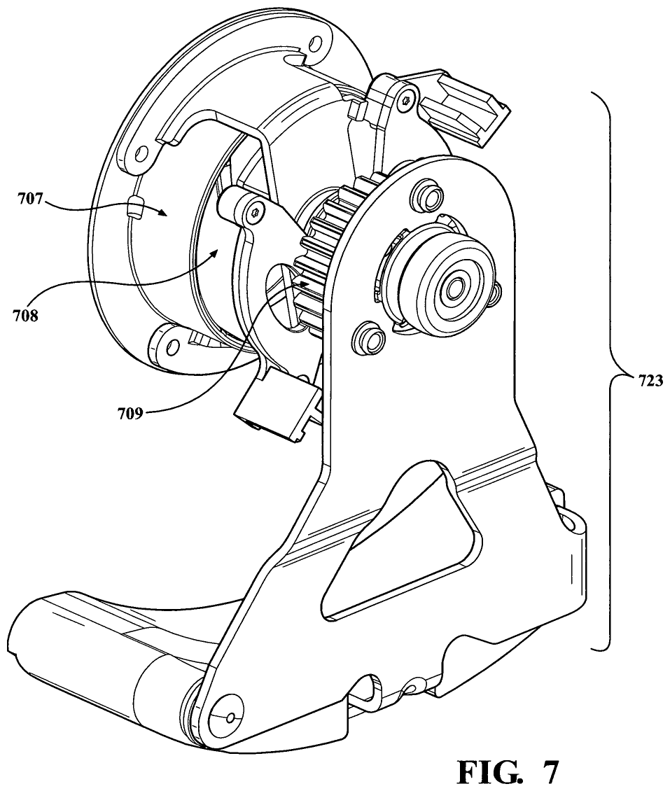

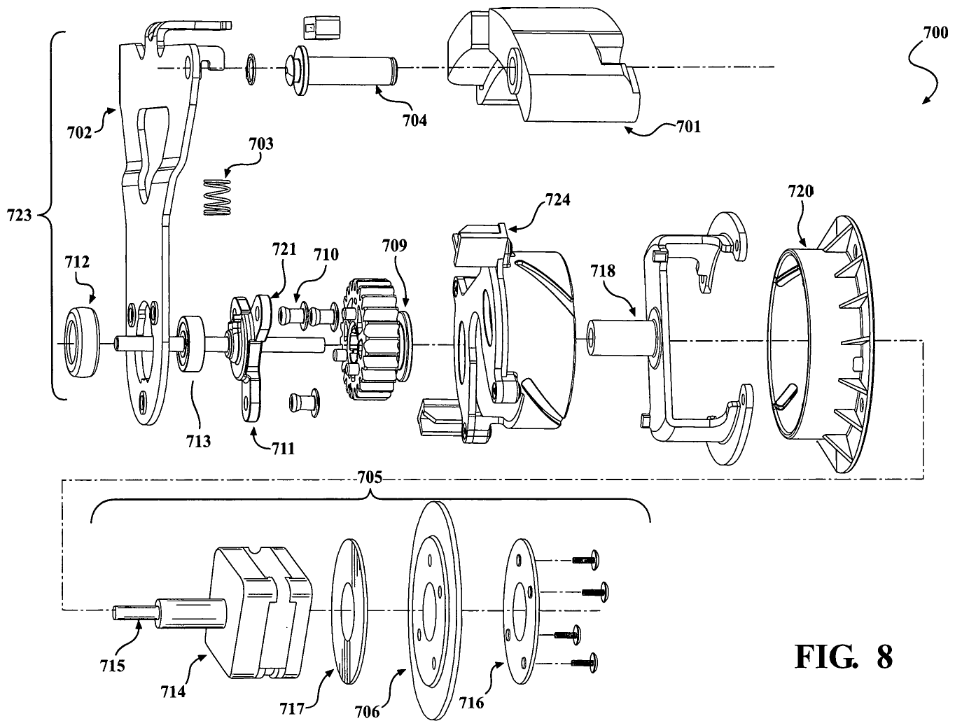

An example embodiment of a power generator in accordance with principles of inventive concepts in system 108 is depicted in FIG. 7 as that portion of the overall system identified as elements contained in system 700, which may be referred to herein as the Energy Harvesting and Power Transmitting System. An isometric view of the energy harvesting and transmitting portion of system 108 is shown in FIG. 7. In FIG. 7, the relationship of the various components that, in example embodiments, constitute this portion of the assembly may be appreciated and will be described in greater detail, for example, in the discussion related to FIG. 8.

The harvesting of energy may occur with the relative rotational movement of the rotatable portion of system 108 with respect to the inertial mass element 723 within the system 108. The rotation of system 108 may be as a result of being attached to a vehicle wheel assembly, which may be in a rotating state as the vehicle is in motion. The energy harvesting and power transmission member 700 within system 108 may be at a non-rotating state as a result of the inertial mass properties of the energy harvesting assembly 701 and the nearly rotational force free design of some of its elements. Relative motion between the system 108 and its internal energy harvesting assembly 701 may provide two types of energy harvesting: mechanical and electrical energy.

As relates to mechanical energy, the relative motion of the Energy harvesting assembly 701 to the other elements of system 108 may result in a torque sufficient in magnitude to power portions of system 108. FIG. 8 provides an exploded view of an example embodiment of an energy harvesting and transmitting portion of a monitoring, analysis and control system 108 in accordance with principles of inventive concepts. The monitoring, analysis and control system energy harvesting device, depending upon configuration and feature content, could be configured as a mechanical energy harvester or an electrical energy harvesting device, or both. The device depicted in FIG. 8 illustrates a mechanical and electrical harvesting device.

The system 708 depicted in FIG. 8 includes an electrical power generating assembly 705. The electrical power generating unit 705 may be mounted such that one portion, the housing assembly 714, may be rotatable relative to another portion of the assembly, the shaft assembly 715. Relative motion, with one element being a stator and another being a rotor may result in the generation of electrical energy. The electrical generating assembly 705 may be mounted to a lower cover of system 108 through its generator housing 714. The generator assembly 705 may have generator housing 714 configured to provide fastening or fixing capability at one end of the assembly and may have a generator shaft assembly 715 that has provisions for attachment at the other end of the generator assembly 705.

The generator housing 714 may be fixed to the lower housing 503 through an isolating elastomer 706, which may be fitted between two elastomer compression limiting discs 716 and 717. The elastomer may provide a degree of isolation between the cover and the electric generator 705 and also may provide accommodation for some amount of misalignment, which could occur in the assembly of the component elements of the unit, for example. The compression discs 716/717 may provide a level of restriction in the excursion that the generator end may experience from the isolator 706. The other end of the electrical generator 705 may be fastened or fixed through the generator shaft 715. The generator shaft 715 may be fixed or fastened to a socket plate 711 and a bearing 713. The bearing may be of conventional construction or may be of bushing type construction utilizing engineered polymers. The engineered polymer possibly providing both a surface capable of high degree of wear resistance and also stability through the application of both strengthening materials or solid lubricants. The bearing or bushing 713 may, in turn, also be attached or coupled to an inertial mass assembly 723, with an attaching socket plate 711 and a set of attaching fasteners 722.

The generator shaft 715 may additionally be supported by a bearing assembly 712 in which the inner race of bearing 712 may be attached to shaft 715 and the outer race of bearing 712 may be affixed an upper cover. The bearing may alternatively be replaced by a polymer bushing as describe for element 713, where the bushing may be fixed to the upper cover 502 and the shaft 715 may freely rotate within the bushing. This configuration, with either bearing/bushing type, may allow the generator shaft assembly 715, which may be firmly fixed to the inertial mass 723, to rotatably move relative to the generator housing assembly 714, which itself may be rotatably affixed to a lower cover. Relative rotating movement between the generator shaft and the generator housing of the generator assembly may produce electrical power.

In example embodiments in accordance with principles of inventive concepts, electrical energy harvesting within system 108 may be a result of a similar relative rotational motion. An electric motor may output a voltage when it is mechanically rotated, operating as electrical generator. In example embodiments in accordance with principles of inventive concepts, an electric motor may be used in this fashion to generate electrical power for system 108. In example embodiments, all, or a portion, of inertial mass assembly 723 mechanical rotational energy may be used to drive a motor, such as a stepper motor, to generate the voltage and electrical current desired to provide electrical power needs of system 108 or similar device. Such a configuration may use a stepper motor 705 with the stator and coils held fixed as part of the housing 714 and the rotor and shaft 715 held fixed to the inertial mass assembly 723 and freely rotating relative to the housing 714, for example. Other motors, such as a Brushless DC (BLDC) motor, Shunt Motors, Series Motors, Permanent Magnet Motors (PMDC), Compound Motors, AC Motors such as Induction and Synchronous Motors and Hybrid Motors such as Hysteresis Motors, Reluctance motors, etc. or any other type of electrical motor or generator, are contemplated within the scope of inventive concepts to generate electrical power.

The power generator assembly 705 may produce a sinusoidal voltage output. Multiple phases of the generator, either combined or singly and either in a filtered or unfiltered state, and in either an AC-like voltage state, or in a Rectified DC state, could be generated in accordance with principles of inventive concepts. Minimal power conditioning of the multiple phases of the sinusoidal voltage may be done for power needed for the higher voltage portion of circuitry, such as, electrical valves, resistive heating elements etc. Additionally, combined phases of the generator processed through either a passive (Resistor/Capacitor/Inductor) conditioning circuit, or a more complex active circuit with diodes (for rectification), and active voltage regulators may provide cleaner DC power sources for electrical operations such as control circuitry, etc. Generator electrical efficiency may be maximized by filtering of generated power, possibly only for the controller (for example, a microprocessor or microcontroller) and associated electronics and may be achieved with Buck/Boost regulators. Minimizing the need/use of conditioned power may allow the use of non-electrolytic capacitor systems and may yield improved system durability.

In example embodiments, power generator assembly 705 generates sufficient power to operate a controller, or main processor (for example, a microcontroller (MCU), a System-on-Chip (SoC), a Field Programmable Gate Array device (FPGA), or a custom Application-Specific Integrated Circuit (ASIC)). Additionally, resistive circuitry elements (such as, but not limited to, Resistors, or resistive traces on circuit boards) may be employed to convert available current flow into heat, resulting in warming of critical parts of a system to prevent freezing or adverse operating conditions. Additionally, such circuit elements could possibly be used to provide a means of removing excess or unwanted moisture in a system by elevating system or area temperature. This heating may be selective and targeted to a specific area, or may be generalized to a system to maintain a desired overall temperature profile range, for example.

The electrical generator 705 may be secured by the electrical generator housing 714 to a lower cover, as previously described. The electrical generator 705 may, in turn, be attached to the energy harvesting member 723 by attachment of the electrical generator shaft 715 via the socket plate 711 and bearing/bushing 713 to the radial support member 702. When system 108 rotates relative to the stationary radial support member 702 and associated elements, as previously described, the electrical generator shaft 715 rotates relative to the electrical generator housing 714 this relative motion results in the potential for the generation of electrical energy.

Although a relative motion between the monitoring, analysis and control system 108 and the inertial mass unit 723 is desirable to generate the aforementioned electrical or mechanical power, it may also be possible that vehicle, road or other factor induced inputs to system 108 could induce undesired oscillations or perturbations of the inertial mass unit 723, possibly aligning the motion of the inertial mass unit 723, to some degree, with the other elements of system 108. In example embodiments in accordance with principles of inventive concepts, such undesirable oscillations or movement of the inertial mass element 723 of the monitoring, analysis and control system 108 may be minimized or interrupted through the selectively short circuiting of two or more legs of the power generator assembly 705 (e.g. stepper motor), thereby causing a braking type force to occur. This could be achieved through control circuitry by applying solid state switching, such as transistors/bipolar or Field-Effect transistor, etc., or through use of mechanical type switches such as relays, etc., for example.

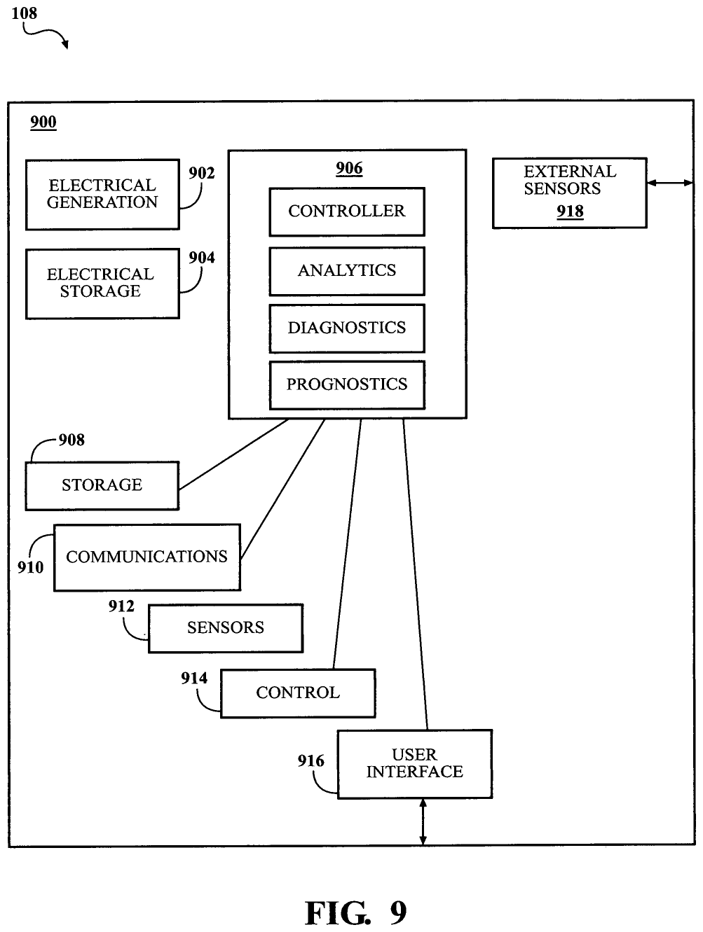

The functional block diagram of FIG. 9 provides a more detailed view of an example embodiment of a wheel-end system 108 in accordance with principles of inventive concepts. System 108 includes an electrical power system 900, controller 906, electronic storage 908, a communications system 910, sensors 912, control electronics 914, a user interface 916, and an external sensor interface 918.

Electrical power system 900 includes electrical power generator 902 (which may be the same as 212 described in relation to FIG. 2) and electrical power storage system 904 (which may be the same as 207 described in relation to FIG. 2). In example embodiments electrical power system 900 operates in conjunction with a mechanical power generator, which is described herein and in a patent application entitled, “APPARATUS AND METHOD FOR VEHICLE WHEEL-END GENERATOR,” having the same inventors and filed on the same day as this application, and which is incorporated by reference in its entirety.

Electronic storage 908 may include volatile or non-volatile electronic memory, such as ROM, EEPROM, Flash, DRAM, phase-change, or other memory. Electronic storage 908 may store sensor readings; controller calculations, analyses, diagnostics, and prognostics; information obtained through user interface 916 (commands, updates, etc.); information obtained through communications interface 910, such as sensor readings, analytics results, diagnostics and prognostics from one or more other systems 108 associated with the same vehicle as the instant system 108; or information or commands from remote devices, such as fleet server 106 or portable communications device 110, for example, through cloud 104.

Communications interface 910 may employ any of a variety of formats and technologies to provide communications among systems 108 associated with a particular vehicle or, directly or through cloud 104, with portable devices 110 or fleet server 106, for example.

Sensors 912 provide readings on tire pressure, tire temperature, motion (e.g., three dimensional accelerometer), wheel temperature, ambient pressure, ambient temperature, wheel temperature, microphone, distance sensors, color sensors, humidity sensors, altimeters, Hall effect sensors, air flow (e.g., Pitot tube), camera (IR, visible, low-light level, etc.), for example Sensor readings may be employed by controller 906 in analytics, diagnostics and prognostics, as described in greater detail herein.

Control electronics may include electromechanical devices, such as solenoids or solenoid valves, employed by controller 906 to control gas flow into or out of tires to thereby ensure proper tire inflation for load-leveling, for proper tire wear, for fuel efficiency, and for safe vehicle operation, for example. A piston control, for operation of one or more pumps, or control for engagement of a clutch or other mechanism to engage or disengage an energy harvesting, or generator, element, such as a inertial mass or quasi-stationary device described herein.

User interface 916 allows a user, such as a vehicle operator, to securely query, adjust, or command a system 108. Input and output through the user interface 916 may employ audio, touchpad, keyboard, stylus, via a standard interface (e.g., USB port), and display, for example.

Controller 906 may be implemented, at least in part, using a microprocessor, microcontroller, application specific processor, system on a chip, or digital signal processor, for example. Controller 906, in addition to controlling the sampling of sensors 917, performs analyses, diagnostics, and prognostics, as described in greater detail herein.

External sensor interface 918 provides communications with sensors that may be external to system 108 such as a camera, for example.

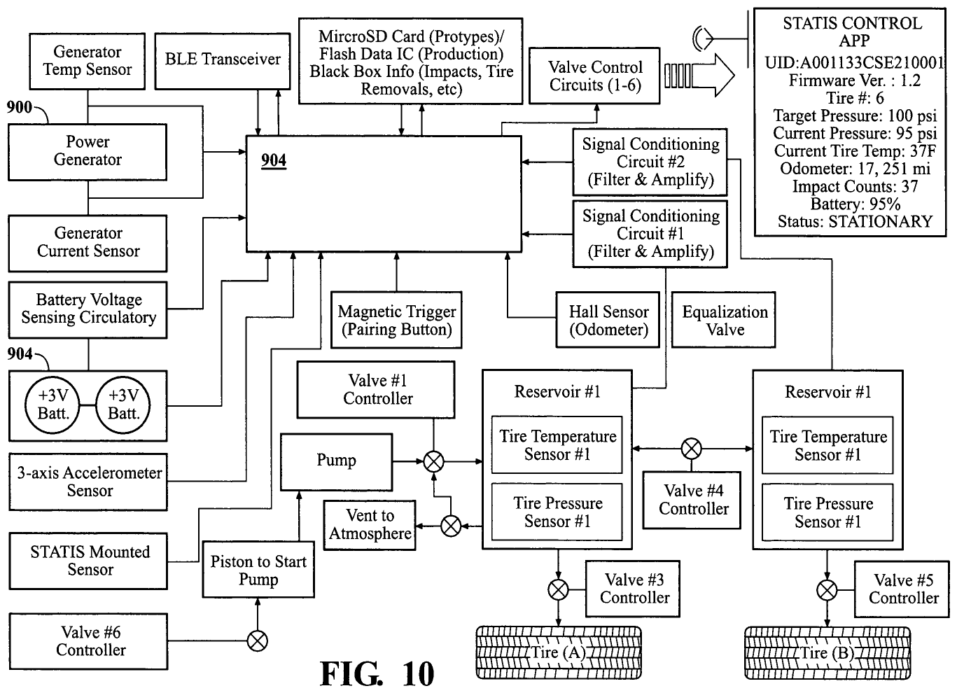

The detailed block diagram of FIG. 10 illustrates a combination of electronics, electromechanical, and mechanical components of system 108, with interfaces to tires (Tire A and Tire B) of a dual-wheel example embodiment. In example embodiments, Statis mounted sensors include slack adjuster inputs and image sensors and BLE refers to a Bluetooth Low Energy transmitter/receiver. In this example embodiment a micro SD card may be used for extended storage during prototyping and a flash card used during production for storing “black box” information, such as impacts (e.g., pothole strikes) and tire removals, for example. Controller 906 employs valve control circuits 1-6 to control a piston (valve 6) to start a pump that employs the previously described mechanical power generator to fill reservoirs 1 and 2, which supply air to tire A and tire B respectively. Controller 906 employs valve 1 to control the supply of air to reservoirs 1 and 2, valve 2 to vent reservoirs to atmosphere, valve 3 to supply or vent air to tire A, valve 5 to supply or vent air to tire B, valve 4 to equalize pressure between reservoirs 1 and 2. A three axis accelerometer is employed to determine various accelerations, as described in greater detail herein, a Hall effect sensor is employed to determine the rotation rate and total rotations of an associated wheel-end, total mileage and so on as described in greater detail herein. Signal conditioning circuits filter and amplify signals, including those from tire temperature sensors 1 and 2 and tire pressure sensors 1 and 2.

In accordance with principles of inventive concepts, system 108 may be controlled using electrical/electronic control systems. Such systems may rely on direct or indirect sensor inputs. The control system may integrate assembled raw data input collected over various time frames or create representations of situations resulting from either predetermined predicted events or as developed as a result of analysis or synthesis of data amassed for trend analysis, for example. In example embodiments this enables the diagnosis of the system's current state or the determination or prediction of future states of the system. In example embodiments such predictive assessments are in the form of transient or steady state predictions. These predictive performance processes and data based unit-specific operational projections allow system 108 to determine or execute actions that may result in the overall tire inflation system being maintained in optimal performing condition or provide an accurate forecast of near term operational performance of the tire(s) associated with system 108. In example embodiments, system 108 may communicate the actions performed or the predictive information to a vehicle operator through user interface 916 or communications interface 910 or a vehicle maintenance/logistics manager at fleet server 106 or portable communications device 110, for example.

Controller 906 may include a number of sensor inputs, including any of those identified herein. Inputs to the main controller 906 (for example, Microcontroller (MCU), System-on-Chip (SoC), Field Programmable Gate Array device (FPGA), or a custom Application-Specific Integrated Circuit (ASIC), etc.), which may be used to calculate Diagnostics and Prognostics for the operational performance or forecast communication of the inflation system, may include those indicated as the functionality of a system in accordance with principles of inventive concepts is further disclosed.

In example embodiments controller 906 may actively and continuously monitor (e.g., many times, per second) all sensors when an associated vehicle or system 108 is in motion, and, upon request, when system 108 is not in motion though, perhaps, at lower frequency rates. Power for the system may be from a power generator 900 (also described as 212), which may provide continual power to system 108 whenever the vehicle is in motion. This continual availability of power may allow sustained sampling protocols for sensors and other inputs at a rate much greater than is possible with fixed energy (e.g. non-rechargeable battery) source devices. These higher sampling rates not only provide a greater level of real-time knowledge of what is transpiring within a vehicle system, but may also allow for much greater capabilities as to signal analysis. In example embodiments, such analyses may include Frequency Analysis and Spectral Analysis (such as, but not limited to Fourier Transforms, Gabor Transforms, Power Spectral Density Analysis, etc.) for the sensor data.

The performance of frequency analysis on various sensors within the system in accordance with principles of inventive concepts provides many benefits. For example, by using Fast Fourier Transforms (FFT's), system 108 may detect frequency abnormalities via one or more accelerometers to provide early warning to a driver (or other) of issues with a tire, for example. Through use of Gabor Transforms, a system in accordance with principles of inventive concepts may develop predictive behavior, thereby enabling the use of Artificial Intelligence in example embodiments. These types of analysis may be possible due to the frequency and volume of sensor data collected, for example, into the Megahertz range and over sustained periods of time (in the range of seconds or greater in example embodiments). Such sampling is made possible as a result of power availability, as generated within system 108. The availability of such a continual power source also allows system 108 to transmit data, analytic, diagnostic, and prognostic results over wireless circuitry at full power without the need for power conservation in example embodiments.

In example embodiments, tire air pressure may be monitored over time (1 sensor per tire, or multiple tires per sensor). Additionally, redundant pressure sensing may be employed. In example embodiments redundant pressure sensing methods may include: direct sensing, which may include primary pressure sensor (s) (Digital or Analog), or indirect sensing, which may include wheel speed & temperature monitoring or other methods. Indirect methods may be utilized as stand-alone monitoring methods or as a means of assessing/confirming performance of direct sensing elements. In addition to pressure monitoring, temperature monitoring may also be provided real time or over time to provide an accurate assessment of the pressure/temperature state of the tire or an inflation reservoir in example embodiments. To that end, example embodiments may use direct sensing using a thermistor or thermocouple, with either providing an analog type of output, or possibly, a temperature sensor providing digital output. The collecting of both the state of pressure associated with a given temperature in example embodiments provides a more complete assessment of the state of a tire or reservoir pressure and determination of actions if any necessary to achieve a desired state.

System 108 may monitor wheel RPM over time to yield diagnostic and prognostic results. In example embodiments, collecting data to assess both speed and distance traveled may be performed both directly and indirectly. In an example embodiment a system includes direct sensing of the rotation of the monitoring, analysis and control system 108 primary shaft axis A through the use of Hall Effect sensors or similar methods, providing both number of rotations as well as an associated time per rotation. In example embodiments, power generator signal phases may be used as a redundant or backup check on actual direct sensors, or may be used in lieu of direct sensors. For example, Hall effect Sensors may be a primary or a direct method of monitoring wheel rotation, to both calculate the wheel rotation speed and for odometer functionality. Use of built in Analog to Digital capabilities of controller 906 to monitor the phase of the electrical generator, allows monitoring of wheel rotations indirectly, for example, by tracking the different phases of the generator The capturing of this information provides both a means of checking Hall Effect sensor performance, with a second method of monitoring wheel rotation and an alternative way to monitor wheel speed, by measuring the frequency of the signal. In example embodiments this provides the ability to closely monitor critical sensor functionality for Tachometer and Odometer functions, as well as, general motion of system 108, with both direct and indirect monitoring methods.

Using wheel rotation monitoring in example embodiments may provide a means of determining miles traveled by system 108 or an associated wheel/tire assembly (for example, by multiplying the number of rotations by the outside circumference of an associated tire). In example embodiments this information may be used internal to assess the current status of the system and to forecast future system status. Additionally, in example embodiments such information may be used to advise the vehicle operator of upcoming periodic mileage-based events, such as filter replacement, tire replacement, or simply providing an axle mileage indicator, which an operator may employ to determine whether to replace an axle or other component, for example.

In example embodiments, the controller may monitor multiple sensors, both direct and indirect, to determine performance status, using tiebreaker logic (both real time, and over time), as well as, nearest neighbor data assessment to determine which sensors are performing adequately and which sensors the system should most trust. In example embodiments this logic may apply to tachometer and odometer functions, as well as other system parameters/sensors within system 108.

Example embodiments of system 108 monitor vibrational inputs to the system through the use of 3-axis accelerometer sensors. These vibrations may come from many sources and their analysis allows system 108 to provide added insight into the overall health of the wheel-end to which system 108 is attached. For example, accelerometer inputs, including both frequency and magnitude, may be analyzed for periodic perturbations of the rotating system, and compared to known issue states. Such data, and associated analysis by system 108, may provide early notification capabilities for such things as tire anomalies such as tread wear, incorrect size tire, tire bulges, tire deformations, foreign objects (e.g., nails, screws or other sharp objects), or other damage, for example, developing wheel-end issues, such as worn bearings, wheel-end and road-induced wheel damage such as locked brakes, damage rims, etc., for example. Additionally, in example embodiments, identifying pot-hole strikes and damage associated with the strike may be provided by a system in accordance with principles of inventive concepts. Time stamps by controller 906 of such an event, along with GPS location data for that time stamp (in example embodiments a GPS receiver is included in system 108 or GPS data may be obtained through communication with a separate system on board the vehicle), may provide documentation for the location of damaging road conditions, providing early identification of deteriorating road conditions, facilitating their rapid repair, or possibly providing documentation of vehicle damage.

In example embodiments, battery voltage status may also be monitored using, for example, direct sensing resistor divider input, providing replacement recommendations when levels fall below a prescribed level. Notifications may be made to the vehicle operator or the logistics manager, possibly multiple times; initially as voltage levels fall to a low, but functional level, and subsequently as levels fall to nonfunctional levels. Where such information may not be available, users may be instructed to replace batteries on prescribed time-based intervals, independent of battery status. Additionally smart battery conditioning and monitoring processes may be employed by a system in accordance with principles of inventive concepts.

Similarly, a system 108 filter assembly may be monitored by the controller for filtering performance, indirectly, for example, by monitoring pumping efficiency, or other sensor or filter performance related data. Should such monitored values reach a targeted level, notification may be sent, for example, to the vehicle operator or a logistics manager (through fleet server 106 or portable communications device 110, for example). There may be multiple levels of notification with regard to filter performance, similar to battery replacement, indicating varying levels of filter contamination. Filter assembly replacement, in the absence of this predictive method of filter assessment, may be done through instructions to a maintenance provider to do periodic time-interval based replacement. A filter assembly may additionally be monitored for actual removal from the vehicle through direct methods, such as use of magnetic switching or make-break contact switching, which could detect the removal of the filter assembly from the lower housing of system 105, or possibly indirect sensing based on “burp” rate differences between the new and old filter with the older filter having slower “burp” rates. The monitoring of filter replacement allows the monitoring of number of miles of active pumping, as well as, total miles, which could be used in determining filter replacement requirements.

In example embodiments, other parameters and functions may also be monitored by system 108. The monitoring of such parameters/systems may provide confirmation of proper ongoing performance or may provide indicators of near term performance issues that may warrant attention or possibly security concerns. Examples of such areas that may be monitored in accordance with principles of inventive concepts include: generator assembly (electrical or mechanical) parameters such as voltage over time, or voltage phase lag possibly using resistor divider input; generator assembly temperature over time, possibly using thermistor, thermocouple or digitals temperature sensors may also be monitored or collected; regulated voltage outputs, including 12V DC Buck/Boost Switching Regulator, associated with elements of the system such as valves, etc., and possibly 3.3V DC Buck Switching or LDO Regulator as may relate to electronic circuitry or the like. Control circuit current consumption may also be monitored, possibly with a Low Ohmic Shunt Resistor or similar means as well as possibly magnetic trigger pairing sensor status for security purposes, and wireless signal strength via Relative Received Signal Strength (RSSI) feature possibly on a Transmitter/Receiver.

In example embodiments, the monitoring of these parameters may provide an indication of many factors, including: vehicle running time, miles traveled, energy harvester and associated bearing health, as well as providing the basis for performance actions such as operational health of the electrical generator, operational health of electrical valves, energy harvester perturbation control, generator oscillations, time and speed based notifications and calculations, authorized or unauthorized removal of the monitoring, analysis and control system 108 from the vehicle, external communications status, etc.

In example embodiments controller 906 may also rely on a Real Time Clock (RTC) to help monitor time for functions that may include both diagnostic and prognostic functions, examples of which are described below. In addition to system time, many short-term events may be closely monitored, such as vibrations per second, etc., and, thus, the internal resources of the controller, such as high-speed timers based on the main oscillator will be frequently used for such purposes, allowing for very accurate short timescale, for example, down to the microsecond range.

In example embodiments, controller 906 may actively and continuously monitor the state of the entire system 108. When the vehicle/system pair is in motion, these element states may include, but are not limited to: state of flow related valve assemblies, state of compressor pump assembly, state of the energy harvesting transmission mechanism, state of filter assembly performance, state of battery assembly, pairing state, with/and between systems 108, nearest monitoring, analysis and control system neighbor(s) state. The controller may also monitor the pairing state of a magnetic pairing sensor. The pairing sensor state change related to the position of lower cover magnet and wheel mounting bracket magnet. The removal of a system 108 from the vehicle may cause a state change in the magnetic pairing sensor. In example embodiments, protocols may be included in the controller that may identify authorized state changes versus those that, in the absence of aforementioned protocols, may be deemed as unauthorized state changes. The protocols may include specified wireless signals to the controller or other removal authorization methods. An unauthorized removal may result in system shut-down, a notification sent to designated entities, etc. Valve assembly, compressor pump, reservoirs, energy harvesting transmission mechanism, and filter assembly are described in greater detail in applications having the same inventors as the instant application, including one entitled, “APPARATUS AND MENTHOD FOR VEHICLE WHEEL-END FLUID PUMPING,” filed on the same date herewith, which are incorporated by reference in their entirety.

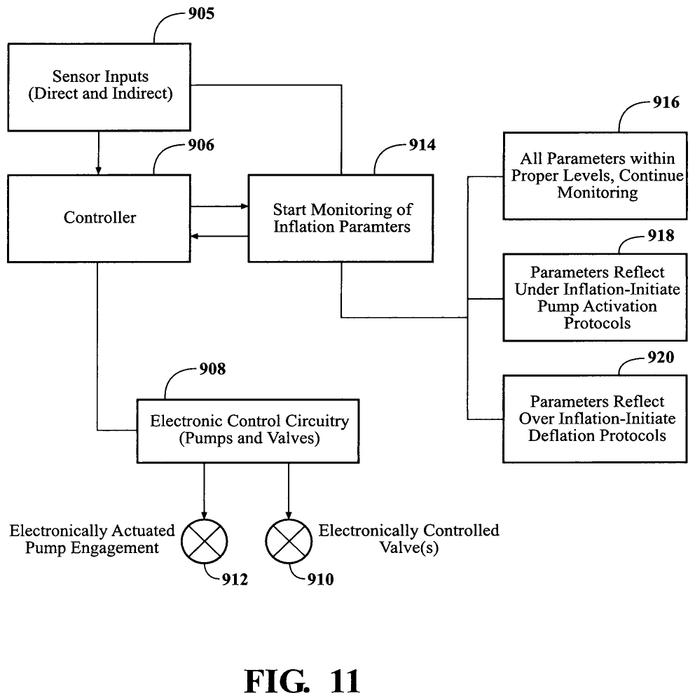

Turning now to FIG. 11, an example embodiment of a system 108 including mechanical, electro-mechanical, and electronic elements in accordance with principles of inventive concepts may include a state position valve and an associated linking pivot and elevator activating arm as described in the discussion related to a mechanical switching system described in greater detail in co-filed applications incorporated by reference herein. The switching system may have one or more switching devices. The switching devices may be coupled and/or pass/receive fluid and/or restrict fluid by use of reservoirs and/or fluid transfer devices which may include hoses, tubes, constructed members to create pathways, internally molded pathways within a member or element, and/or a combination of any and/or all these methods and/or constructs.

The state position valve, the switching devices and/or other control devices may be actioned, or activated, with a pulse width modulated (PWM) set of inputs controlled by the controller 906 or, for example, direct current (DC) control, which may be supplied directly from the electrical power generator or other methods. The selection of PWM and/or generator DC may be determined based on a number of factors, including open time and/or power on duration, heat build-up, power budget, power conditioning capability, etc. For example, PWM may reduce power loads on the system and generate less heat and allow a more efficient system operation, while power supplied directly from the power generator will allow an added degree of simplicity with a lesser need for power conditioning.

An exemplary embodiment of an electrical activated switching system may be constructed to allow the control of valves, for example, valves 910 that, in turn, control the fluid and/or air paths within the system, as depicted schematically in FIG. 11. The valves in an electronic control embodiment in accordance with principles of inventive concepts may be controlled by a controller 906 that may activate electronic control circuitry 908 (which may include elements of previously described electrical system 216) to open and close various valves in the system, depending on the inputs received from direct and indirect sensors, as well as being directly controlled by a mobile app, for example. Electronic control circuitry 908 may also operate a pump actuation system 912 to engage or disengage a pump to compress fluid for tire inflation, for example.

In example embodiments, system 108 may monitor temperatures and pressures of the tire(s) and using logic within controller (a MCU, for example), may use multiple inputs to confirm the integrity of the sensor inputs and then decide whether to simply keep monitoring the system, to inflate the system, or, for example, to deflate a tire or other components of the system by engaging the pump and opening and closing valves in the airflow path. There may be planned inflation protocols, deflation protocols, pump activation protocols, and monitoring protocols, all to be contained within in the main controller, for example.

In example embodiments switching device may include a plurality of valves that may be actuated by electrical signals. These valves and/or switches may be configured to provide a closed and/or an open position and may be configured to provide control of fluid passage and/or may actuate mechanical elements within the system. There may be a configuration that provides control of fluid within one or a plurality of tires and/or reservoirs. An exemplary system may include one or more sensors. The sensor(s) may assess such parameters as pressure and temperature or other system characteristics, for example. The sensor(s) are positioned to provide access to parameters generated within or by a tire and/or reservoir of interest. Parameter data may be periodically and/or continuously monitored by a control module. Controller 906 receives selected input data from one or more sensors, performs a variety of calculations, comparisons, and/or analysis on the incoming data, which may result in activation of one or more valves and/or switching devices. The operation of these switching devices may be simultaneously and/or in a prescribed order. The duration of activation of these switching devices also may be varied based on a prescribed activation protocol.

In example embodiments in accordance with principles of inventive concepts, the switching system shown in FIG. 10 may operate according to the logic diagram FIG. 11. In example embodiments, controller 906 monitors inflation parameters 914, including a plurality of sensor inputs, such as tire pressure, temperature, accelerometer inputs, etc., as well as analysis results and longitudinal results (for example, sensor inputs and analysis results over time). The monitoring process ensures that all parameter values are within a proper range 916, and, if so, continues monitoring the parameter values. If parameter values indicate that a tire is under-inflated, pump activation protocols may be initiated 918 to engage a pump using, for example, electronic control circuitry 908 and electronically activated pump engagement elements 912 (for example, solenoids or electric motor). A tire may be “under-inflated” in a variety of senses. For example, for load-leveling, a tire may be considered under-inflated if it is at a lower pressure than other tires on a vehicle, either on the same wheel-end or on another wheel-end. Or, a tire may be under-inflated in the sense that it is below a preset threshold pressure.

Similarly, if parameter values indicate that a tire is over-inflated, pump activation protocols may be initiated 920 to engage a pump using, for example, electronic control circuitry 908 and electronically activated pump engagement elements 912 (for example, solenoids or electric motor). A tire may be “over-inflated” in a variety of senses. For example, for load-leveling, a tire may be considered over-inflated if it is at a higher pressure than other tires on a vehicle, either on the same wheel-end or on another wheel-end. Or, a tire may be over-inflated in the sense that it is above a preset threshold pressure.

In such example embodiments, should a sensor detect a pressure reading below targeted level, a first sensor or second sensor may read a low pressure, which may be transmitted to controller 906. Controller 906 may signal, or command, an opening of a switch/valve having fluid transmission passage leading to a tire or other reservoir, or a second switch/valve having fluid transmission passage leading to a second tire or other reservoir, and a simultaneous or subsequent opening of a third switch/valve which may be for a prescribed duration. The opening of third switch/valve, subsequent and/or coincident to the opening of first switch/valve or second switch/valve, may cause pressurized fluid to enter state position unit, resulting in activation of torque transmission system and operation of pumping system.

Pumping of fluid by the pumping system may flow into discharge reservoir. The controller 906 may periodically activate switch/valve, based on analysis of various system related parameters. The opening of either or both valves may result in charging the first or second tire or a reservoir. The system may continue to operate in this manner, until the controller 906 determines, based on data sampling and/or analyses, a change action should occur. One such action may be the termination of pumping. Such an action may result from Controller 906 signaling a close status for first or second switch/valve, a subsequent opening of discharge switch/valve leading to atmosphere, or coincidently an opening of third switch/valve. The opening of both switches/valves may result in a lowering of pressure in the/a cavity leading to state position valve which, as described previously, may result in the disengagement of torque/force transmission device and subsequent termination of pumping by pumping system.

With two tires connected to a system 108 and the valving of the system may be operated with intent to equalize pressures within and between a dual set of tires. In such an example embodiment, readings from sensors associated with each tire are in a state of difference. Equalization would entail the following: opening a first valve for a prescribe period and then shutting it. Tire pressure in a first tire may inflate discharge reservoir to pressures as experienced in first tire. First valve is then opened for a prescribed period of time and then shut again filling discharge reservoir this time with pressure from second tire. The process may continue, alternating the opening and shutting process between the first and second valves until first and second sensors achieve a like reading. Alternatively, both first and second valves could be maintained in an open state at the same time for a prescribed period of time and then both shut. This could allow flow of air between the tires and thus equalizing of tire pressure.

In order to reduce pressure in an over-inflated tire, system 108 operate as follows. Tire over-inflation may be as a result of a variety of factors, such as heating of the ambient environment as the vehicle travels from one climate to another, and/or operational heating, for example. The adjustment of such a condition may include the relieving of pressure from the overinflated tire by opening first or second valve, as determined to be the tire exhibiting an over pressure condition for a predetermined period of time. The air from the tire flows into discharge reservoir then the discharge valve is opened for a prescribed period, thereby discharging reservoir to atmosphere. This process may be repeated until the sensor that indicated excess pressure provides a target pressure reading.

In accordance with principles of inventive concepts, system 108 may be controlled using electrical/electronic control systems. Such systems may rely on both direct and/or indirect sensor inputs. The control system may integrate assembled raw data input collected over various time frames and/or create representations of situations resulting from either predetermined predicted events and/or as developed as a result of analysis and/or synthesis of data amassed. In example embodiments this enables the diagnosis of the system's current state and/or the determination and/or prediction of future states of the system. In example embodiments such predictive assessments are in the form of transient and/or steady state predictions. These predictive performance processes and data based unit-specific operational projections allow system 108 to determine and/or execute actions that may result in the overall tire inflation system being maintained in optimal performing condition and/or providing an accurate forecast of near term operational performance of the tire(s) within the system. In example embodiments, this control system is capable of communicating both the actions performed and/or the predictive information to a vehicle driver and/or the vehicle maintenance/logistics manager at fleet server 106 or portable communications device 110, for example.

In addition to system performance monitoring, in example embodiments the controller 906 may also perform diagnostics. One such diagnostic is the use of a non-contact thermal monitoring method, using, for example, infrared thermal sensors. These thermal monitors may provide an indicator of potential issues within systems being monitored, for example, related to elevated temperatures, or analysis of elevated temperatures and frequency of elevation, or the rise rate in temperatures of a system/component, etc. Thermal sensor monitoring may be performed on components/systems within the confines of system 108 or external to system 108. System 108 monitoring, for example, the electrical generator 902 or support bearings may provide early warning indicators of binding conditions and or other high friction situations. Frequent heating of the pumping system may, reveal, for example, issues with valving within the pump cylinder head or elsewhere.

Temperature sensor monitoring from system 108 may also be employed on locations external to system 108. Directing thermal sensors on preselected positions on the wheel or wheel hub, may provide information relating to wheel bearing status (e.g. binding from improperly adjusted wheel bearings, deteriorating bearing elements, etc.), brake status (e.g. brake drag from improperly functioning brake adjusters, corroded elements, etc.), etc. A system and method in accordance with principles in accordance with principles of inventive concepts may thereby provide an indicator of properly performing systems, and identify deteriorating systems when issues are in their infancy, before major issue develop.

Additional systems that may be monitored in example embodiments of system 108 using a variety of sensing for diagnostics may include an evaluation of the following: Sensor Performance—in example embodiments the controller compares a first sensor's values to a second sensor's values immediately after corresponding reservoirs have been equalized. If differences are greater than acceptable threshold, comparison of other values on the sensor modules in system 108 may be executed to identify an errant sensor. Additionally, a backup pressure sensor verification assessment may be performed by assessing system rotations and wheel speed. A given tire pressure may result in a rotational speed for a given diameter at a designated vehicle speed. Comparing sensors values to same axle “neighbors” may provide axle speed and tie-breaking methodology may identify the errant sensor. Repeating the process of setting tire set-points at adjusted pressures may be employed to assess whether the errant sensor has a calibration issue or has a read capability issue. The calibration issue may be correctable based on a possible calibration adjustment based on “neighbor” sensor values methodology. Temperature sensor performance may be assessed in a similar manner coincidently with the assessment of the pressure sensor. Monitoring performance over time may allow an assessment of the health and performance of both the pressure and temperature sensors and a history of any past divergences.

In example embodiments of a system 108 in accordance with principles of inventive concepts controller 906 may perform a number of operations to assess the functional health of the electrical generator assembly 902. Such operations may include, for example, controller 906 comparing temperature and current to nonvolatile flash memory threshold value; saving RPM, current and temperature readings to nonvolatile memory and reporting any threshold variances; monitoring voltage phase lag; initiating generator braking circuitry (for example, applying a large load by shorting two legs of the generator output together for a short time) to counteract oscillation and to re-stabilize the pendulum, in response to oscillation determined by controller's analysis; monitoring generator performance under various states (such as before and during pumping, before, during and after Valve actuation, etc.) to determine an electrical fingerprint (current, voltage and phase lag of generator) during the pumping. System 108 monitors this electrical fingerprint will over time to help complete the health check of the generator and to monitor potential problems with the pendulum and other generator components.

Controller 906 may monitor valve performance, for example, by manually pressurizing a reservoir and measuring and monitoring a pressure leak rate for each reservoir and comparing the leak rate to a threshold value (stored, for example, in nonvolatile memory). Controller 906 may save the leak rate and report any threshold variances. Controller 906 may monitor generator performance before and during valve actuation to determine an electrical fingerprint (current, voltage and phase lag of generator) during the actuation. This electrical fingerprint is monitored over time to help complete the health check of the valves and their control circuitry. For example, an increasing leak rate may indicate deterioration of valves, hose, or other fluid system components.

Controller 906 may monitor compressor and piston performance by self-testing by pressurizing a reservoir for this operation as needed (for example, on a regularly scheduled maintenance basis) comparing pressure rise rate to a threshold value, saving the rise rate readings and reporting any threshold variances. Controller 906 may monitor Generator performance before and during pumping to determine an electrical fingerprint (current, voltage and phase lag of generator) during the pumping. This electrical fingerprint will be monitored over time to help complete the health check of the compressor pump (and piston performance). For example, in original condition the pump may require a given number of cycles (e.g., 200) to increase pressure by one PSI, but, over time, the compressor pump may require more cycles (e.g., 250) to increase pressure by the same amount. Monitoring these values over time and analyzing the changes and rate of change may be used in accordance with principles of inventive concepts to predict failure or advise maintenance, for example.

In addition to diagnostics, a system in accordance with principles of inventive concepts may collect current state information and, based on analysis of that data, with a prior knowledge of system state performance or other information, may forecast future system performance events or, through real time actions, avoid negative outcomes.

Such forecasts may include an assessment of leak rate, as well as an identification of low pressure. This may include an identification of a low-pressure state and a determination of pumping system “ON” or pumping time requiring the identified low-pressure tire to attain proper, or targeted pressure level. It may also include a monitoring of time between re-inflation events and the time that the pumping system may be in an “ON” or pumping state. To that end, each low-pressure event may be tracked in a Fill Tire Protocol functions, where information tracked may include parameters such as, mileage, date, time, fill time, etc. A comparison may be made to nearest neighbor (for example, a second tire on the same wheel-end or a second tire on the opposing end of an axle, or a second tire on the nearest neighboring wheel-end) performance, as well as, an expected performance data set. A calculation of the tire pressure loss rate may be done, with collected data, for example, including the aforementioned data or including: fills per given distance (100 miles, for example); or fills per given time span (one day, for example) if there may be periods of vehicle idle time in the assessed period; fill period or active duty time of the pumping system, temperature rise rate per given distance (for example, per mile), temperature rise rate for a given time period (for example, per minute), comparison of temperature change to “nearest neighbors”, etc. The use of the data identified and the knowledge of pumping system performance capability may be employed in accordance with principles of inventive concepts to project system's 108 ability/capability to maintain system target pressures, or the duration that target pressures may be maintained. This information may be communicated to the vehicle operator or a logistics manager, allowing a proper assessment of type of maintenance actions that may be desired/taken or scheduled based on such forecasts.

Monitoring of the electrical generator assembly generated electrical signature and comparison to expected performance bands. This comparison may identify initiation of potential/possible abnormalities. Such abnormalities may include, among other observances, oscillations of the energy-harvesting mass 723, based on indicators such as phase perturbations within the electrical signal. These oscillations, if unheeded, could result in fluctuations in power transmission performance or could require adjustment of the inertial mass of the energy harvesting system. Adjustments to minimize such oscillations may be employed, based on managing or manipulating electrical and mechanical induced force or load demands placed on the energy harvesting system, as well as, through the selectively short circuiting of two (or more) legs of the power generator assembly (e.g. stepper motor) causing a braking type force to occur, as previously described.

General vehicle health and predictive assessments of same may also be provided in example embodiments, through the collection or assessment of operating parameters developed by the various monitoring, analysis and control system units on a given vehicle. The information collected may be used in total or in various combinations such as, across vehicle on “shared” axles, or “like side neighbors” or tractor to trailer, as well as other combinations. Parameters that may be collected for such combining and parsing may include, but are not limited to; wheel rotational speed; wheel accelerations/vibrations across multiple axis; temperatures, both transient and steady state; etc. The collecting and combining of information in combination with a review of preferred performance and difference between or amongst may allow identification for instance of brake drag due to improper slack adjuster or other similar induced brake retraction issues. This may initially be seen with a comparison of wheel rotational numbers, globally on the vehicle initially and with refinement cross axle, potentially followed, if not resolved, by temperature differences between hubs. Number of wheel rotation analysis may also reveal axle misalignments. An axle-to-axle analysis may indicate that one axle is not aligned perpendicular to the vehicle's travel direction and, thus, scrubbing and causing excessive tire wear. Vibrational analysis of accelerometer data, may be employed to identify out-of-round wheels, or dented wheels, or impending delamination. Each would be assessed based on differing combinations of accelerometer data combinations and the signature of the accelerometer data captured.

In operation, a system 108 may employ a classifier to analyze sensor readings, use sensor readings to diagnose system 108 and associated vehicle states or prognosticate future system 108 or associated vehicle states, for example, in regard to maintenance or possible faults or failures. Readings from any sensor may be used, singly, or in combination with readings from other sensors. In the following example, readings from an accelerometer will be used for illustrative purposes, but inventive concepts are not limited thereto.

In operation, a sensor, which may be a three-axis accelerometer, for example, detects vibrations, converts the mechanical vibrations to an analog electrical signal, conditions the signal (using, for example, an electrical filter and multi-stage gain amplifier) converts the analog electrical signal to a digital signal and passes the digital signal to controller 906. Various of these operations may take place in either the sensor or processor 906. In exemplary embodiments in accordance with principles of inventive concepts, data may be pre-processed, for example, by performing normalization, feature scaling, and regularization to enhance the accuracy of a sensor system in accordance with principles of inventive concepts.

As will be described in greater detail below, in exemplary embodiments processor 906 converts the time domain signal (time vs amplitude) received from the sensor to the frequency domain (frequency vs amplitude), then transforms the frequency domain signal to a spectrogram image (frequency vs time). In exemplary embodiments in accordance with principles of inventive concepts, a time/amplitude representation may be converted directly to a time/frequency representation. Wavelet transforms may be employed to perform such a transformation, for example. During regular operation, this image is then employed by a trained classifier, described in greater detail below, which may be implemented on controller 906, for example, to identify characteristic values that can be matched to corresponding calibration characteristic values associated with a plurality of conditions associated with system 108 or an associated vehicle (for example, a flat tire, a bulge on a tire, a locked brake, etc.).

During calibration, or training, this image may be employed by a classifier to characterize, or classify, the vehicle conditions and to store those classifications for use during normal sensing operation. In exemplary embodiments in accordance with principles of inventive concepts a classifier may be trained on a vehicle used exclusively for such calibration activities and the models developed thereby downloaded to sensors in the field for sensing operation. Libraries of such models, for different vehicles and different conditions, for example, may be developed and distributed to sensors for operation in the field. For repeatability, the vehicle and conditions used for training the classifier may be substantially similar to the vehicle and conditions using the model in the field for sensing.

Generally, an artificial neural network consists of units (neurons), arranged in layers, that convert an input vector into an output. Each unit receives an input, applies a function, which may be a nonlinear function, to the input and passes the output on to the next layer. Networks are generally defined to be feed-forward. Weightings are applied to the signals passing from one unit to another, and it is these weightings that are tuned in the training phase to adapt an artificial neural network to a problem, the entire process of which may be referred to herein as creating a classifier model. During training, the number of classes desired and the class identification of each training sample is known. That is, for example, if tire failure information is to be determined within one percent accuracy, the number of classes may be set at one hundred, and training data for each of the one hundred levels is presented to the classifier for training. This information, the number of classes and class identification of each training sample is used to determine the desired net output and to compute an error signal. The error signal indicates the discrepancy between the actual and desired outputs and is used to determine how much weights assigned to neurons should be changed to improve the performance for subsequent inputs. Once trained in this fashion, a classifier may respond to an input by providing an indication of which of the classes most closely matches the input.

Analog and digital implementations are both contemplated within the scope of inventive concepts and, although a digital implementation is the focus of the detailed description of exemplary embodiments an analog implementation employing, for example, phase change cells as neurons, or neural nodes, is contemplated within the scope of inventive concepts.

In an exemplary embodiment in accordance with principles of inventive concepts, an artificial neural network model is trained using samples at condition (or degree of failure, for example) of interest. For improved accuracy, even smaller increments may be employed. The number of training samples for each condition may vary widely, from only one to hundreds, depending upon vehicle, condition, and environmental factors, and depending upon the desired resolution. In order to compensate for issues such as background noise, intermittent vibrations, or other environmental factors, a sensor system in accordance with principles of inventive concepts may be trained over a period of time under different circumstances.

Once trained, the classifier model may be stored and used for vehicle condition determination on the same classifier upon which it was developed or the classifier model may be loaded onto another classifier and employed to determine conditions of the same or other vehicles. In this manner, a single classifier may be trained for a given vehicle and associated conditions and the model transferred to a multitude of sensors in the field (for example, thousands of sensors on vehicles distributed throughout the country). The model, or more precisely, model parameters, such as synaptic weights, may be transferred through the cloud, through dedicated networks, such as wide area networks, or local area networks, and may be updated using the same communication link when, for example, more precise models become available or to accommodate a new vehicles, new vehicle components, or new material contained therein, for example.

In exemplary embodiments in accordance with principles of inventive concepts, results may be obtained from a vehicle installation, where vibration may be sampled at 16 kHz for one second, yielding approximately 16,000 data points. This time domain signal may be conditioned and converted, via Discrete Fourier Transform (DFT) into the frequency domain. The frequency domain representation may then be further transformed to a frequency vs time spectrogram. The spectrogram, a frequency vs time image, may then be supplied to a classifier trained as described above. In exemplary embodiments in accordance with principles of inventive concepts, data may then be pre-processed, for example, by performing normalization, feature scaling, and regularization to enhance the accuracy of a sensor system in accordance with principles of inventive concepts. The classifier provides an output indicative of which of the classes, which vehicle condition, the input signal corresponds with.

Experimental results may be obtained using a classifier contained within system 108, but it is contemplated within the scope of inventive concepts that the classifier may be housed on a dedicated server accessed by a sensor unit's communication link. Such a server may be situated “on the cloud” or a dedicated local or wide area network, for example, allowing a sensor system to gather and condition data points and forward the data to a central processor for classification/analysis. In this manner, a system in accordance with principles of inventive concepts may reduce the cost and power consumption of each of the systems 108, allowing for more efficient classification and relatively easy updates on a dedicated and optimized server (such as fleet server 106, for example).

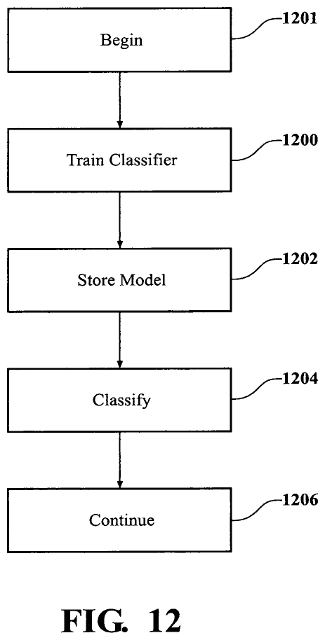

The flow chart of FIG. 12 depicts a method of sensing in accordance with principles of inventive concepts. In particular, the method entails training a classifier to generate a model 1200 including correlations to a plurality of vehicle conditions, storing the model 1202, and employing a trained model to recognize a vehicle condition 1204. In this example embodiment a classifier model is trained with acoustic, or vibrational, data corresponding to acoustic signatures in different vehicle conditions. The model may then be stored on a server, for access by systems 108 in the field, or may be downloaded directly to such systems 108 for use in the field. In exemplary embodiments, a robust model is trained, with various vehicle conditions. Additionally, variations in temperature and other vehicle conditions may be used to train the classifier and, as a result, library models corresponding to various vehicle conditions, such as tire inflation, tire damage, vehicle bearings, load conditions, at various temperatures, etc. may be constructed.

To ensure accuracy, the same mechanism, vehicle, or simulation may be used during training as may be used in the field. Additionally, entries in the model library may be associated with similar vehicle constructions (having similar mechanical properties that generate responses that are similar within a range of responses), similar vehicle construction (size, shape, weight), similar sensor location on a vehicle and similar temperatures.

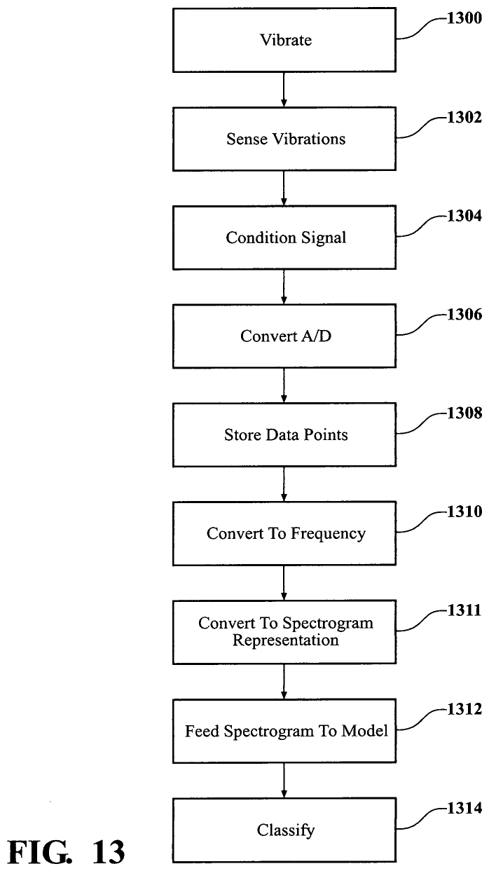

The flow chart of FIG. 13 depicts an exemplary embodiment of “normal” or “field” operation (that is, sensing operation, as opposed to training operation), of an exemplary embodiment of a system 108 in accordance with principles of inventive concepts. The exemplary process begins in step 1300, where vehicle conditions, such as road travel, sets up vibrations in the vehicle being monitored, or sensed. Signal conditioning may accommodate a variety of signal levels to, for example, avoid signal clipping or other signal range-related challenges.

In step 1302 sensor system 108 senses the vibrations. In exemplary embodiments, the sensor is a three axis accelerometer employing a microelectromechanical (or piezoelectric charge type, for better temperature stability) device, but inventive concepts are not limited thereto and training and operation with any sensor (for example, pressure, temperature, humidity, etc.,) or analytical result is contemplated within the scope of inventive concepts. In step 1304 the signal generated by the sensor is conditioned, for example, by filtering and amplification in a two-stage gain amplifier. The resulting conditioned signal is converted from analog to digital form in step 306 and stored in step 308. A number of data points may be collected in this manner. For example, in exemplary embodiments approximately sixteen thousand such data points are collected over the course of one second, but inventive concepts are not limited thereto. The number of data points collected may be reduced or increased, depending upon environmental or design factors, for example.

The conditioned signal from step 1308 is then converted from a time domain signal to a frequency domain signal, (that is, from an amplitude versus time signal to an amplitude versus frequency signal) using, for example, a Fast Fourier Transform (or Discrete Fourier Transform) in step 1310. The frequency domain signal representation of step 1310 is then further transformed into a spectrogram representation in step 1311. In step 1312 the spectrogram representation is fed to the classifier model to determine the vehicle condition of interest. That is, a classifier model associated with a similar vehicle developed in accordance with principles of inventive concepts is employed by system 108 that accepts input a spectrogram representation developed in step 1312 and, depending upon the response of the classifier model, determines the vehicle condition in step 1314.

That is, in exemplary embodiments, the spectrogram representation of a vehicle's condition of interest is compared in, or classified by, an artificial neural network classifier, but inventive concepts are not limited thereto. Classifiers and the training thereof are known and described, for example in “Unsupervised Feature Learning For Audio Classification Using Convolutional Deep Belief Networks,” by Honglak Lee, et al, Computer Science Department, Stanford University, published in Proceedings, ICML '09 Proceedings of the 26^{th} Annual International Conference on Machine Learning, pages 609-616, ACM New York, N.Y., USA, ISBN: 978-1-60558-516-1, which is hereby incorporated by reference.

While the present inventive concepts have been particularly shown and described above with reference to example embodiments thereof, it will be understood by those of ordinary skill in the art, that various changes in form and detail can be made without departing from the spirit and scope of inventive concepts as defined by the following claims.

What is claimed is:

1. A monitoring system for attachment to a wheeled vehicle wheel-end, comprising:
a sensor to sense a physical characteristic of a vehicle to which the monitoring system is attached;
a controller to collect readings from the sensor; and
the controller to employ the sensor readings to analyze operation of the vehicle.

2. The monitoring system of claim 1, wherein the analysis of sensor readings includes trend analysis.

3. The monitoring system of claim 1, wherein the analysis of sensor readings includes diagnosis of the functionality of the monitoring system.

4. The monitoring system of claim 1, wherein the analysis of sensor readings includes the diagnosis of the functionality of the vehicle.

5. The monitoring system of claim 4, wherein the diagnoses of the functionality of the vehicle includes diagnosing the pressurization state of a tire associated with a wheel-end to which the monitoring system is attached.

6. The monitoring system of claim 4, wherein the diagnoses of the functionality of the vehicle includes diagnosing the pressurization state of a plurality of tires associated with a wheel-end to which the monitoring system is attached.

7. The monitoring system of claim 4, wherein the diagnoses of the functionality of the vehicle includes diagnosing the state of an axle associated with the wheel-end to which the monitoring system is attached.

8. The monitoring system of claim 4, wherein the diagnoses of the functionality of the vehicle includes diagnosing the state of bearing associated with the wheel-end to which the monitoring system is attached.

9. The monitoring system of claim 1, wherein the controller is configured to prognosticate, or predict, changes in the vehicle.

10. The monitoring system of claim 9, wherein the controller is configured to predict when a tire associated with the wheel-end to which the monitoring system is attached should be replaced.

11. A method in a monitoring system for attachment to a wheeled vehicle wheel-end, comprising:
a sensor to sensing a physical characteristic of a vehicle to which the monitoring system is attached;
a controller to collecting readings from the sensor; and
the controller employing the sensor readings to analyze operation of the vehicle.

12. The method of claim 11, wherein the analysis of sensor readings includes trend analysis.

13. The method of claim 11, wherein the analysis of sensor readings includes diagnosis of the functionality of the monitoring system.

14. The method of claim 11, wherein the analysis of sensor readings includes the diagnosis of the functionality of the vehicle.

15. The method of claim 14, wherein the diagnoses of the functionality of the vehicle includes diagnosing the pressurization state of a tire associated with a wheel-end to which the monitoring system is attached.

16. The method of claim 14, wherein the diagnoses of the functionality of the vehicle includes diagnosing the pressurization state of a plurality of tires associated with a wheel-end to which the monitoring system is attached.

17. The method of claim 14, wherein the diagnoses of the functionality of the vehicle includes diagnosing the state of an axle associated with the wheel-end to which the monitoring system is attached.

18. The method of claim 14, wherein the diagnoses of the functionality of the vehicle includes diagnosing the state of bearing associated with the wheel-end to which the monitoring system is attached.

19. The method of claim 11, wherein the controller is configured to prognosticate, or predict, changes in the vehicle.

20. The method of claim 19, wherein the controller is configured to predict when a tire associated with the wheel-end to which the monitoring system is attached should be replaced.
